(19) United States
(12) Patent Application Publication
(10) Pub. No.: US 2024/0402206 A1
(43) Pub. Date: Dec. 5, 2024

(54) SYSTEMS, DEVICES, AND METHODS FOR REAGENT STORAGE IN AUTOMATED CELL PROCESSING

(71) Applicant: Cellares Corporation, South San Francisco, CA (US)

(72) Inventors: Andrew BOPPART, San Francisco, CA (US); Jebsen MAN, San Mateo, CA (US); Andrew Philip Gust PETERSON, San Francisco, CA (US); Wilson Wai TOY, San Francisco, CA (US); Peter TURNER, Brisbane, CA (US)

(21) Appl. No.: 18/731,095

(22) Filed: May 31, 2024

Related U.S. Application Data
(60) Provisional application No. 63/470,381, filed on Jun. 1, 2023.

(51) Int. Cl. G01N 35/10; G01N 35/00; G01N 35/04

(52) U.S. Cl. CPC G01N 35/1002; G01N 35/1004; G01N 2035/00435; G01N 2035/00752; G01N 2035/0443

(57) ABSTRACT

The present disclosure relates to systems, devices, and methods for automated reagent storage within a cell processing system. In an embodiment, the present disclosure relates to a reagent vault system comprising a refrigeration unit for storing cell processing reagents, a rotating carousel configured to receive one or more fluid devices, the fluid devices configured to store the cell processing reagents, and at least one sensor for measuring at least one parameter of the reagent vault system.

### CROSS REFERENCE TO RELATED APPLICATIONS

This application claims priority to U.S. Provisional Patent Application No. 63/470,381, filed Jun. 1, 2023, the contents of which are hereby incorporated in their entirety by this reference.

### TECHNICAL FIELD

The present disclosure relates to systems, devices, and methods for reagent storage, for example, reagent storage for use within an automated cell processing system.

### BACKGROUND

Cell therapy processes sometimes require multiple reagents per cell therapy process and multiple days to complete. These cell therapy processes may require multiple reagents, to be used at various time points throughout the processes at staggered intervals. Complicating this process, some reagents must be refrigerated or otherwise maintained at a particular temperature prior to use. However, storing and accessing multiple reagent storage containers for high-throughput processes creates operational complexities that are difficult to overcome with traditional reagent storage systems.

For example, reagent storage systems typically have limited capacity such that a relatively low number of storage containers may be stored at any given time. It may also be difficult to identify a specific storage container within the reagent storage system, particularly when a significant quantity of storage containers is present within the same reagent storage system. Typical reagent storage systems also require manually loading and unloading by operating personnel. As noted above, some reagents must be refrigerated prior to use. Intermittent access by operating personnel may disrupt the environment of the reagent storage system or the underlying cell therapy processing. Additionally, some reagents must be sterilized prior to use. Sterilization cycles may require a significant amount of time to run, during which time the storage containers may be inaccessible. Accordingly, additional systems and methods for reagent storage in automated cell processing are desirable.

### SUMMARY

The present disclosure relates generally to systems, devices, and methods for reagent storage within an automated cell processing system. In general, the reagent storage systems described herein may comprise a reagent vault system. The reagent vault system may comprise a refrigeration unit for storing cell processing reagents, a rotating carousel configured to receive one or more fluid devices, and at least one sensor for measuring at least one parameter of the reagent vault system. The reagent vault system may comprise a single unit housing the refrigeration unit, rotating carousel, and at least one sensor. The unit may comprise an outer door for user access to the rotating carousel and an inner door for access to cell processing instruments within a sterile workcell. The reagent vault system may comprise an interlock configured to lock the outer door when the inner door is open, or vice versa. The fluid devices may be configured to store cell processing reagents, cell samples, or cell processing waste byproducts. The fluid devices are also capable of being emptied of these materials (e.g., for waste removal). The reagent vault system may further comprise a scanner configured to scan a bar code of one or more fluid devices and detect a size of one or more fluid devices. Additionally, the reagent vault system may comprise a sterilization nozzle to provide sterilant to the one or more fluid devices.

In some variations, the reagent vault system may comprise a robotic arm for transferring one or more fluid devices from the rotating carousel to one or more instruments within a cell processing workcell. The robotic arm may comprise a fluid device engagement feature end effector for coupling to one or more fluid devices.

The reagent vault system may further comprise a just-in-time feedthrough for loading one or more time-sensitive reagents into the reagent vault system. The just-in-time feedthrough may temporarily house reagents or other materials that are to be delivered immediately before use within the workcell. Other uses of the just-in-time feedthrough may be to bring in single reagent containers (e.g., for process deviations), as well as to offload samples. The just-in-time feedthrough may comprise a sterilization nozzle to provide sterilant to one or more time-sensitive reagents. The reagent vault system may comprise a waste unit.

Methods of reagent storage in automated cell processing are also described herein. The methods may comprise loading a rotatable carousel of a reagent vault system with a fluid device, scanning a bar code of the fluid device with a scanner, and moving the fluid device from the rotatable carousel to an instrument within a cell processing workcell using a robotic arm. The rotatable carousel may be within a reagent vault system comprising a refrigeration unit, the scanner, and at least one sensor for measuring at least one parameter of the reagent vault system. Loading the rotatable carousel may comprise loading multiple fluid devices into the rotatable carousel. In some variations, the methods comprise scanning at least two fluid devices of different sizes with a scanner to determine that the fluid devices are of different size. The methods may further comprise providing a sterilant to sterilize the fluid device. The methods may comprise alerting a user if the measured temperature within the reagent vault system is greater than a threshold temperature. In some embodiments, the threshold temperature can be a set value that falls within a temperature range.

Additional embodiments, features, and advantages of the invention will be apparent from the following detailed description and through practice of the invention.

### BRIEF DESCRIPTION OF THE DRAWINGS

FIG. 1 is a block diagram of an illustrative variation of a cell processing system.

FIG. 2A and FIG. 2B are renderings of an illustrative variation of a cell processing system.

FIGS. 3A and 3B are illustrative renderings of reagent vault systems that may be used with the systems and methods described herein.

FIG. 4 is an exploded view of an illustrative variation of various components of a cell processing system.

FIG. 5 is a block diagram of an illustrative variation of a robot.

FIG. 6 is an illustrative rendering of one variation of a robot that may be used with the systems and methods described herein.

FIGS. 7A-7C provide illustrative renderings of one variation of an end effector of a robot engaging with a fluid device as described herein.

FIG. 8 is a block diagram of an illustrative variation of a reagent vault system.

FIG. 9A is an exploded view of an illustrative variation of a reagent vault. FIG. 9B is a non-exploded, partial view of the reagent vault of FIG. 9A.

FIG. 10 is a block diagram of an illustrative variation of a sensor system of a reagent vault.

FIG. 11 is a rendering of an illustrative housing variation of a sensor system of a reagent vault.

FIG. 12 is a block diagram of an illustrative variation of a carousel of a reagent vault system.

FIG. 13A is a side view of an illustrative variation of a carousel of a reagent vault. FIG. 13B is a side view of an illustrative variation of a carousel of a reagent vault. FIG. 13C is a top view of an illustrative variation of a carousel of a reagent vault. FIG. 13D is a perspective view of an illustrative variation of a carousel of a reagent vault.

FIG. 14 is a block diagram of an illustrative variation of a scanner system of a reagent vault.

FIG. 15A is a partially exploded view of an illustrative scanner system of a reagent vault.

FIG. 15B is a perspective view of the scanner system of FIG. 15A.

FIG. 16 is a block diagram of an illustrative variation of a just in time feedthrough.

FIG. 17A is an exploded view of an illustrative variation of a just in time feedthrough.

FIG. 17B is a rendering of an illustrative variation of a just in time feedthrough.

FIG. 18 is a block diagram of an illustrative variation of a waste unit.

FIG. 19A and FIG. 19B are renderings of an illustrative variation of a waste unit.

FIG. 20A, FIG. 20B, and FIG. 20C are flowcharts of illustrative variations of a reagent storage method in a reagent vault.

FIG. 21A and FIG. 21B are flowcharts of illustrative variations of a reagent storage method in a just in time feedthrough.

FIG. 22 is a flowchart of an illustrative variation of a waste disposal method in a waste unit.

### DETAILED DESCRIPTION

Disclosed herein are devices, systems, and methods for storing reagents, cell products, and/or other fluids for use in an automated cell processing system or workcell. The disclosed devices, systems, and methods may be used with a wide range of fluid devices, and in some variations, the devices, systems, and methods disclosed herein utilize multiple reagent vaults to improve operational capability and efficiency. As described throughout, the reagent storage methods, devices, and systems may involve moving a fluid device containing a cell product between a reagent vault system and a plurality of instruments inside a workcell. One or more instruments may be configured to interface with a fluid device to perform cell processing steps. In some variations, a plurality of fluid devices may be stored within a single reagent vault. In some variations, the plurality of fluid devices may be moved within the workcell by a robotic arm. The reagent vault system may comprise a reagent vault, a just-in-time feedthrough, and a waste unit.

The workcell may process two or more fluid devices in parallel. For example, each of the reagent vault, just-in-time feedthrough, and waste unit may be configured to interface with a fluid device. In this way, more than one of the reagent vault, just-in-time feedthrough, and waste unit may be in use at any given time. The cell processing systems described herein may reduce operator intervention and increase throughput by automating fluid device movement between locations using a robot. However, in some variations, the fluid device may be moved between locations manually.

### I. Cell Processing System

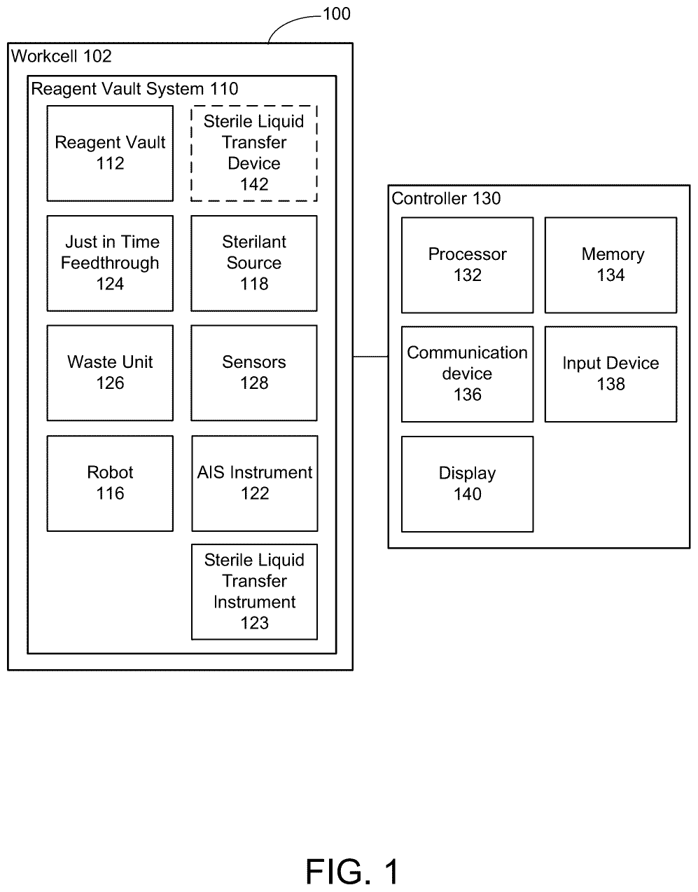

An illustrative cell processing system for use with the instruments, systems, and methods is shown in FIG. 1. Shown there is a block diagram of a cell processing system 100 comprising a workcell 102 and controller 130 (also referred to as a workcell controller). In some embodiments, the workcell 102 comprises a reagent vault system 110. The reagent vault system 110 may comprise a reagent vault 112, a just-in-time feedthrough 124, a sterilant source 118, a waste unit 1216, an automatic in-process sampling (AIS) instrument 122, a robot 116 (e.g., a robotic arm or other suitable robot), and one or more sensors 128. The reagent vault system 110 may also comprise one or more fluid devices in the form of a sterile liquid transfer device (SLTD) 142. The controller 130 may comprise one or more of a processor 132, a memory 134, a communication device 136, an input device 138, and a display 140. FIG. 1 also shows a sterile liquid transfer instrument (or SLTI) 123. In some embodiments, the SLTI 123 is an instrument that interacts with both an SLTD 142 and a consumable cartridge. Accordingly, in some embodiments, it can be considered part of the reagent vault system 110.

The workcell 102 may comprise a fully, or at least partially, enclosed housing inside which one or more cell processing steps are performed in a fully, or at least partially, automated process. In some variations, the workcell 102 may be an open system lacking an enclosure, which may be configured for use in a clean room, a biosafety cabinet, or other sterile location.

The fluid container or fluid device may be referred to as an SLTD 142. One or more fluids may be stored in the SLTD 142. For example, the SLTD 142 may contain a time-sensitive reagent, a cell sample, or a cell processing byproduct. The time-sensitive reagent may be any reagent that degrades, or otherwise becomes less efficacious over time, for example, gene modification reagents including viral vectors (e.g., lentivirus and adenovirus), electroporation master mixes, and the like. The sterile liquid transfer devices described herein throughout are typically portable fluid devices that may be moved within the cell processing system 100. For example, the SLTD 142 may be moved using the robot 116 to reduce manual labor in the access, storage, and transfer of reagents required during cell processing steps. The sterile liquid transfer devices and fluid connectors described herein may help enable the transfer of fluids in an automated, sterile, and metered manner for automating cell therapy processing.

In some variations, the robot 116 may be configured to move at least one SLTD 142 between different instruments of the cell processing system 100 to perform a predetermined sequence of cell processing steps. In this way, multiple SLTDs 142 may be stored and accessed in parallel, as different steps of the cell processing sequence may be performed at the same time on different SLTDs.

Any suitable cell processing may be performed using the systems and devices described herein, and may include steps such as growing, enriching, selecting, sorting, expanding, activating, transducing, electroporating, washing, and the like. For example, a method of processing a solution containing a cell product may include the steps of digesting tissue using an enzyme reagent to release a select cell population into solution, enriching cells using a counterflow centrifugal elutriation (CCE) instrument, washing cells using the CCE instrument, selecting cells in the solution using a selection instrument, sorting cells in the solution using a sorting instrument, differentiating or expanding the cells in a bioreactor, activating cells using an activating reagent, electroporating cells, transducing cells using a vector, and finishing a cell product.

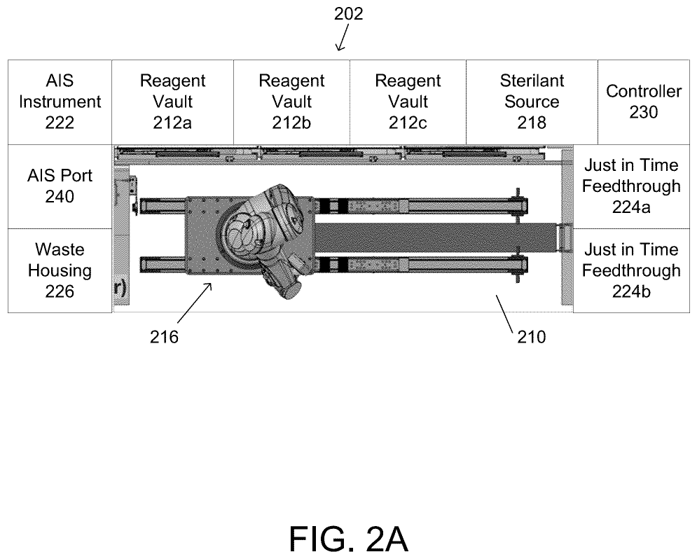

FIGS. 2A and 2B show illustrative cell processing systems for use with the devices, systems, and methods described herein. Shown there is a cell processing system comprising a workcell 202 that may be divided into an internal zone 210, a waste unit 226, an AIS instrument 222, an AIS port 240, a first reagent vault 212a, a second reagent vault 212b, a third reagent vault 212c, a sterilant source 218, a controller 230, a first JIT feedthrough 224a, and a second JIT feedthrough 224b. The AIS port 240 may be connected to the AIS instrument 222 via tubing, valves, doors, access ports, or other means. The AIS instrument 222 may be configured to perform a sampling process on at least one SLTD. For example, the sampling process may comprise removing a volume of fluid from at least one SLTD, measuring at least one parameter associated with the volume of fluid, and communicating the at least one measurement to the controller 230. An SLTD may be transferred between locations within the workcell 202 via a robot 216.

The robot 216 may have access to multiple compartments and instruments via doors that open into the internal zone 210. The doors that open into the internal zone 210 may be referred to as inner doors. The workcell 202 may comprise an air filtration inlet (not shown) that provides high-efficiency particulate air (HEPA) filtration to provide ISO7, ISO8, IOS9, or better air quality in the internal zone 210. This air filtration may help maintain a sterile cell processing manufacturing environment. The workcell 202 may also have an air filter on the air outlet to preserve the ISO rating of the room. The robot 216 may be configured to move an SLTD in a predefined sequence to a plurality of locations, with the components of the workcell 202 being controlled by the computer processor of the controller 230. The workcell 202 may comprise one or more moveable barriers (e.g., access port, door) configured to facilitate access to one or more of the instruments, the reagent vault, JIT feedthrough, and waste unit. For example, a human operator may load one or more SLTD into one or more the reagent vault, JIT feedthrough, and waste unit via an outer door that opens into the external environment.

The workcell 202 may further comprise, inside the interior zone 210, a cell separation instrument 216 (e.g., magnetic separation instrument), an electroporation instrument 220, a counterflow centrifugation elutriation (CCE) instrument 222, a sterile liquid transfer instrument 224, and a spinoculation instrument 230. Each instrument may be received within a slot or bay. In some variations, different instruments can be combined at one slot or bay, such that two or more instruments can interact with a cartridge 214 (shown in FIG. 2B, and also referred to as a consumable cartridge) positioned in the bay. The cartridge 214 may be transferred to (i.e., loaded into) the workcell 202 via a cartridge feedthrough 207. The robot 216 (e.g., a support arm, robotic arm, or the like) may be configured to move the cartridge 214 from the cartridge feedthrough 207 to any instrument and/or bay. The cartridge 214 may comprise one or more of a cell separation system, an electroporation module, a fluid transfer bus, a sensor, and a fluid connector. The cartridge 214 may be moved using the robot 216 to reduce manual labor in the cell processing steps, and sterile liquid transfers into and out of the cartridge may also be performed in a fully or partially automated process. For example, the cartridge 214 may be connected to an SLTD via a sterile liquid transfer instrument. The devices and fluid connectors described herein may help enable the transfer of fluids in an automated, sterile, and metered manner for automating cell processing.

The sterilant source 218 may be connected via tubing to each of the reagent vaults 212a, 212b, 212c and the JIT feedthrough 224. The sterilant source 218 may comprise a storage tank configured to contain at least one sterilant or decontaminant. The sterilant or decontaminant may be configured to sterilize any external surface of any component of the workcell 202. An SLTD stored within one of the reagent vaults 212a, 212b, 212c and JIT feedthrough 224 may be pre-sterilized, or the reagent vault 212a, 212b, 212c and the JIT feedthrough 224 may sterilize the SLTD using sterilants or decontaminants provided by a sterilant distributor fluidically and/or electrically connected to the sterilant source 218. The sterilant or decontaminant may comprise ultraviolet radiation (UV) or chemical sterilizing agents, such as ionized hydrogen peroxide (iHP), provided as a spray or wash. The reagent vaults 212a, 212b, 212c and the JIT feedthrough 224 may optionally be configured to automatically and/or periodically spray, wash, irradiate, or otherwise treat fluid devices prior to their use, or during the cell processing procedure (e.g., with ethanol and/or isopropyl alcohol solutions).

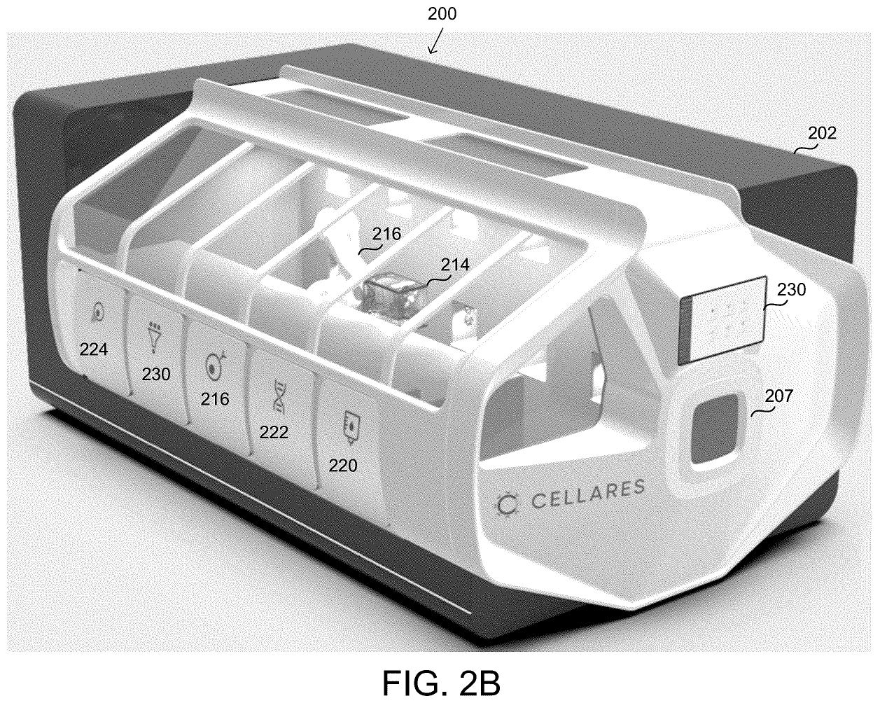

FIG. 3A and FIG. 3B show illustrative variations of a workcell 302. In an exemplary embodiment, a first reagent vault 312a, a second reagent vault 312b, and a third reagent vault 312c are shown as part of the workcell 302 with a controller 330. The corresponding outer doors for each reagent vault are also shown. For example, a first outer door 316a of the first reagent vault 312a is adjacent to a second outer door 316b of the second reagent vault 312b, and the second outer door 316b is adjacent to a third outer door 316c of the third reagent vault 312c. In an exemplary embodiment, the workcell 302 may further comprise a waste unit 326 and a JIT feedthrough 324. The waste unit 326 may be positioned adjacent to the first reagent vault 312a. In some variations, the reagent vaults 312a, 312b, 312c may be positioned on a first sidewall of the workcell 302 and the waste unit 326 may be positioned on a second sidewall of the workcell 302. In some variations, the reagent vaults 312a, 312b, 312c and waste unit 326 may be positioned on the same sidewall of the workcell 302. Similarly, in some variations, the JIT feedthrough 324 may be positioned on a third sidewall of the workcell 302. In some variations, at least a portion of each of the reagent vaults 312a, 312b, 312c, JIT feedthrough 324, and waste unit 326 may be accessible from the interior zone 310. While three separate reagent vaults, side-by-side, are shown in FIGS. 3A and 3B, it should be understood that such configurations are merely illustrative. Indeed, any number of reagent vaults may be provided with the systems and methods described here. For example, the systems may have one, two, three, four, five, six, or even more reagent vaults, depending on the nature of the cell processing to be performed. In some embodiments, the systems and methods described herein can also include one, two, three, four, five, six, or even more waste units and JIT feedthroughs. Similarly, while the reagent vaults shown in FIGS. 3A and 3B are shown as being side-to-side or adjacent one another, they need not be. Indeed, they may be positioned in a way to best optimize the utilization and space requirements of the workcell. Lastly, while shown herein throughout as being largely rectangular in shape, the reagent vaults may be of any suitable geometry. When more than one reagent vault is provided, the reagent vaults need not be the same geometry.

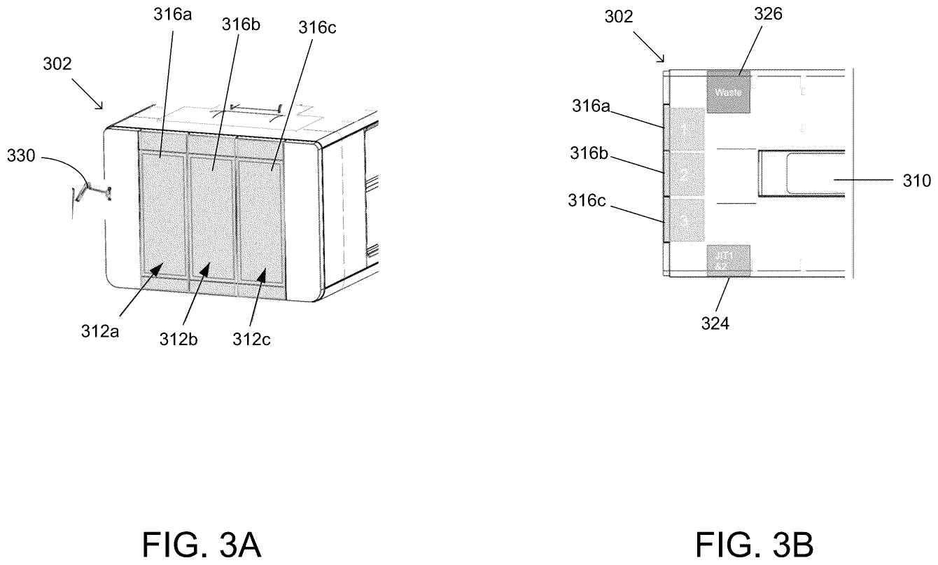

Returning to the figures, FIG. 4 shows an exploded view of exemplary variation of several components of a workcell 402. The workcell 402 may comprise a first reagent vault system 412a, a second reagent vault 412b, and a third reagent vault 412c. Each reagent vault may comprise an inner door. A first inner door 418a may be coupled to the first reagent vault 412a, a second inner door 418b may be coupled to the second reagent vault 412b, and a third inner door 418c may be coupled to the third reagent vault 412c. Each inner door may be configured to open into the interior zone of the workcell 402 such that a portion of a robot 416 may access the contents of each reagent vault. The workcell 402 may further comprise a waste unit 426 and an AIS assembly 430. The AIS assembly 430 may comprise an AIS instrument and an AIS port (not shown). The waste unit 426 and AIS assembly 430 may be housed on the same structure or may be housed on separate structures. In some variations, the structure may comprise a cart or other storage structure having at least one wheel configured to move the structure around the workcell 402. The workcell 402 may further comprise a sterilant cabinet 440, a first JIT feedthrough 424a, and a second JIT feedthrough 424b. The sterilant cabinet 440 may comprise at least one sterilant distributor and/or sterilant source. The sterilant cabinet 440 and JIT feedthroughs 424a, 424b may be housed on the same structure, or may be housed on separate structures. In some variations, the structure may comprise a cart or other storage structure having at least one wheel configured to move the structure around the workcell 402.

Other suitable cell processing systems and aspects thereof are provided e.g., in U.S. patent application Ser. No. 17/198,134, published as U.S. Patent Publication No. 2021/0283565, which is incorporated by reference herein.

### A. Workcell

i. Controller

With reference now back to FIG. 1, the cell processing systems described herein may comprise a controller 130 (e.g., computing device) comprising one or more of a processor 132, memory 134, communication device 136, input device 138, and display 140. The controller 130 may be configured to control (e.g., operate) any component or setting within the workcell 102. The controller 130 may comprise a plurality of devices. For example, the workcell 102 may enclose one or more components of the controller 130 (e.g., processor 132, memory 134, communication device 136) while one or more components of the controller 130 may be provided remotely to the workcell 102 (e.g., input device 138, display 140).

ii. Processor

The processor (e.g., processor 132) described here may process data and/or other signals to control one or more components of the system. The processor may be configured to receive, process, compile, compute, store, access, read, write, and/or transmit data and/or other signals. Additionally, or alternatively, the processor may be configured to control one or more components of a device (e.g., console, touchscreen, personal computer, laptop, tablet, server).

In some variations, the processor 132 may be configured to access or receive data and/or other signals from one or more of workcell 102, server, controller 130, and a storage medium (e.g., memory, flash drive, memory card, database). The processor 132 may be any suitable processing device configured to run and/or execute a set of instructions or code and may include one or more data processors, image processors, graphics processing units (GPU), physics processing units, digital signal processors (DSP), analog signal processors, mixed-signal processors, machine learning processors, deep learning processors, finite state machines (FSM), compression processors (e.g., data compression to reduce data rate and/or memory requirements), encryption processors (e.g., for secure wireless data transfer), and/or central processing units (CPU). The processor may be, for example, a general-purpose processor, Field Programmable Gate Array (FPGA), an Application Specific Integrated Circuit (ASIC), a processor board, and/or the like. The processor may be configured to run and/or execute application processes and/or other modules, processes and/or functions associated with the system. The underlying device technologies may be provided in a variety of component types (e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and the like.

The systems, devices, and/or methods described herein may be performed by software (executed on hardware), hardware, or a combination thereof. Hardware modules may include, for example, a general-purpose processor (or microprocessor or microcontroller), a field programmable gate array (FPGA), and/or an application specific integrated circuit (ASIC). Software modules (executed on hardware) may be expressed in a variety of software languages (e.g., computer code), including structured text, typescript, C, C++, C#, Java®, Python, Ruby, Visual Basic®, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. Additional examples of computer code include, but are not limited to, control signals, encrypted code, and compressed code.

iii. Memory

The cell processing systems and devices described here may include a memory (e.g., memory 134) configured to store data and/or information. In some variations, the memory may include one or more of a random-access memory (RAM), static RAM (SRAM), dynamic RAM (DRAM), a memory buffer, an erasable programmable read-only memory (EPROM), an electrically erasable read-only memory (EEPROM), a read-only memory (ROM), flash memory, volatile memory, non-volatile memory, combinations thereof, and the like. In some variations, the memory may store instructions to cause the processor to execute modules, processes, and/or functions associated with the device, such as image processing, image display, sensor data, data and/or signal transmission, data and/or signal reception, and/or communication. In some variations, a computer storage product with a non-transitory computer-readable medium (also may be referred to as a non-transitory processor-readable medium) having instructions or computer code thereon for performing various computer-implemented operations is used. In these variations, the computer-readable medium (or processor-readable medium) is non-transitory in the sense that it does not include transitory propagating signals per se (e.g., a propagating electromagnetic wave carrying information on a transmission medium such as space or a cable). The computer code (also may be referred to as code or algorithm) may be those designed and constructed for the specific purpose or purposes. The memory may be configured to store any received data and/or data generated by the controller and/or workcell. In some variations, the memory may be configured to store data temporarily or permanently.

iv. Input Device

In some variations, an input device 138, for example, may comprise or be coupled to a display. The input device may be any suitable device that is capable of receiving input from a user, for example, a keyboard, buttons, touch screen, etc. The input device may include at least one switch configured to generate a user input. For example, an input device may include a touch surface for a user to provide input (e.g., finger contact to the touch surface) corresponding to a user input. An input device including a touch surface may be configured to detect contact and movement on the touch surface using any of a plurality of touch sensitivity technologies including capacitive, resistive, infrared, optical imaging, dispersive signal, acoustic pulse recognition, and surface acoustic wave technologies. In embodiments of an input device including at least one switch, a switch may have, for example, at least one of a button (e.g., hard key, soft key), touch surface, keyboard, analog stick (e.g., joystick), directional pad, mouse, railball, jog dial, step switch, rocker switch, pointer device (e.g., stylus), motion sensor, image sensor, and microphone. A motion sensor may receive user movement data from an optical sensor and classify a user gesture as a user input. A microphone may receive audio data and recognize a user voice as a user input.

In some variations, the cell processing system may optionally include one or more output devices in addition to the display, such as, for example, an audio device and haptic device. An audio device may audibly output any system data, alarms, and/or notifications. For example, the audio device may output an audible alarm when a malfunction is detected. In some variations, an audio device may include at least one of a speaker, a piezoelectric audio device, a magnetostrictive speaker, and/or a digital speaker. In some variations, a user may communicate with other users using the audio device and a communication channel. For example, a user may form an audio communication channel (e.g., VoIP call).

Additionally, or alternatively, the system may include a haptic device configured to provide additional sensory output (e.g., force feedback) to the user. For example, a haptic device may generate a tactile response (e.g., vibration) to confirm user input to an input device (e.g., touch surface). As another example, haptic feedback may notify that user input is overridden by the processor.

v. Communication Device

In some variations, the controller may include a communication device (e.g., communication device 136) configured to communicate with another controller and one or more databases. The communication device may be configured to connect the controller to another system (e.g., Internet, remote server, database, workcell) by wired or wireless connection. The system may be in communication with other devices via one or more wired and/or wireless networks. In some variations, the communication device may include a radiofrequency receiver, transmitter, and/or optical (e.g., infrared) receiver and transmitter configured to communicate with one or more devices and/or networks. The communication device may communicate by wires and/or wirelessly.

vi. Display

Image data may be output on a display (e.g., display 140) of a cell processing system. The display may include at least one of a light emitting diode (LED), liquid crystal display (LCD), electroluminescent display (ELD), plasma display panel (PDP), thin film transistor (TFT), organic light emitting diodes (OLED), electronic paper/e-ink display, laser display, and/or holographic display.

vii. Graphical User Interface

In some variations, as indicated above, a GUI may be configured for designing a process and monitoring a product. For example, the GUI may be a process design home page. The GUI may indicate that no processes have been selected or loaded. A create icon (e.g., “Create a Process”) may be selectable for a user to begin a process design process. In some variations, one or more of the GUIs described herein may include a search bar.

viii. Robot

Generally, a robot of the workcell may comprise any mechanical device capable of moving a fluid device, such as an SLTD, from one location to another location within the workcell. For example, the robot may comprise a mechanical manipulator (e.g., an arm) in a fixed location, or attached to a linear rail, or a 2- or 3-dimensional rail system. While shown in some of the figures as being fixed in place or with respect to a rail system, the robot need not be so. For example, in some variations, the robot comprises a wheeled device. Any number of robots may be used within the workcells described herein. For example, the workcell may comprise two or more robots of the same or different type (e.g., two robotic arms each independently configured for moving fluid devices between instruments). The robot may also comprise an end effector for precise handling of different fluid devices, barcode scanning, or radio-frequency identification tag (RFID) reading.

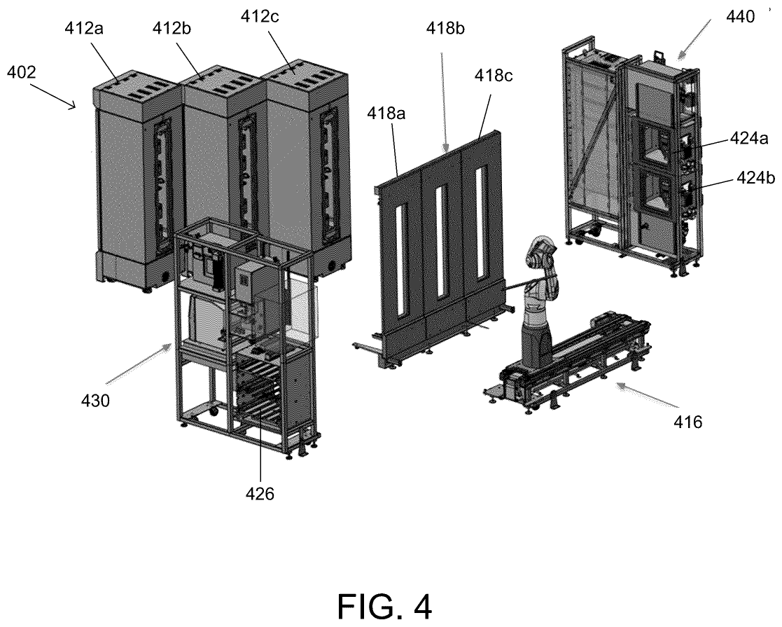

FIG. 5 shows an illustrative block diagram of a robot for use with the devices, systems, and methods described herein. In some variations, a robot 116 may comprise a robotic arm 510. The robotic arm 510 may be coupled to a cart 530 that is connected to a rail 522a. In some variations, the robotic arm 510 may be coupled to a cart 530 that is connected to each of the rails 522a, 522b. In some variations, there may be two or more carts 530, each cart having a robotic arm 510, on the same rails 522a, 522b. In some variations, there may be more than one robotic arm 510 on a single cart 530.

The cart 530 may move along the rails 522a, 522b via at least one rail motor 526. The rail motor 526 may be operatively coupled to a transportation feature of the cart 530. For example, actuation of the rail motor 526 may rotate at least one wheel of the cart 530. Actuation of the rail motor 526 may be controlled by a controller. In some variations, actuation of the rail motor 526 may occur automatically and without input from a user. In this way, the rail motor 526 may be controllably actuated to move the robot along the rails 522a, 522b in any direction. In some variations, the cart 530 may be manually moved along the track 522 by, for example, a user. In some variations, the movement of the cart 530 may occur simultaneously with movement of the robotic arm 510 via actuation of the arm motor 520.

The rails 522a, 522b may comprise two parallel rails, each comprising a length. In some variations, the length of the two rails 522a, 522b may be the same. However, in other variations, they may be different. The length of each rail may independently be about 1 foot, about 2 feet, about 3 feet, about 4 feet, about 5 feet, about 6 feet, about 7 feet, about 8 feet, about 9 feet, about 10 feet, about 15 feet, and about 20 feet. In some embodiments, the length of the rail may be greater than 20 feet. The rails 522a, 522b may be substantially straight or may be contoured or curved. In some variations, the rails 522a, 522b may each form a circle, however other geometries may also be used. For example, the rails 522a, 522b may each form a square, a rectangle, a triangle, or any other multi-segment shape.

The robotic arm 510 may further comprise at least one arm motor 520 and an end effector 512. The at least one arm motor 520 may be configured to move any part of the robotic arm 510 in any direction. For example, the robotic arm 510 may comprise one, two, three, or more joints. Each joint may act as a connection point between longitudinal segments of the robotic arm. Each joint may be coupled to the same or different arm motors. Each joint may be configured to rotate about a rotational axis defined by the joint and/or arm motor 520. In this way, the arm motor may rotate at least one longitudinal segment. The arm motor 520 may be configured to rotate at least one longitudinal segment approximately 360 degrees. In some variations, the robotic arm 510 may have multiple degrees of freedom based on the number of joints and arm motors 520. In some variations, the robotic arm may have six degrees of freedom. The end effector 512 may comprise a gripper 514 comprising one or more indexing, gripping, or engagement features configured to engage a corresponding engagement feature on a fluid device, SLTD, and/or consumable cartridge. For example, the gripper 514 may be configured to engage at least one corresponding feature on an SLTD. The end effector 512 may further comprise a scanner 516 and/or a proximity sensor 518. The scanner 516 may comprise a laser barcode reader configured to read a barcode on an outer surface of an SLTD. The proximity sensor 518 may be configured to detect a distance between the end effector 512 and any component within the workcell. For example, the proximity sensor 518 may measure a distance between the end effector 512 and an SLTD. The proximity sensor 518 may also be configured to measure a size of an SLTD. For example, the proximity sensor 518 may measure at least one dimension of the SLTD by continuously or semi-continuously measuring the SLTD as the end effector 512 is moved. The proximity sensor 518 may comprise an optical sensor, a laser sensor, an infrared sensor, a Doppler effector sensor, an ultrasonic sensor, a radar sensor, or any other suitable sensor.

The robot 116 may further comprise a robot interlock 524. The robot interlock 524 may be configured to prevent further movement of the robot along the rails. In some variations, the robot interlock 524 may be configured to prevent further movement of the robotic arm 510. The robot interlock 524 may be activated manually, such as by a user, or automatically. For example, the robot interlock 524 may be automatically activated if one or more sensors of the workcell measures a value beyond the desired operating conditions (e.g., temperature, pressure, and/or humidity). In some variations, the robot interlock 524 may be activated based on a door opening within the workcell. The robot interlock 524 may be a button, a lever, or an icon in a graphical user interface.

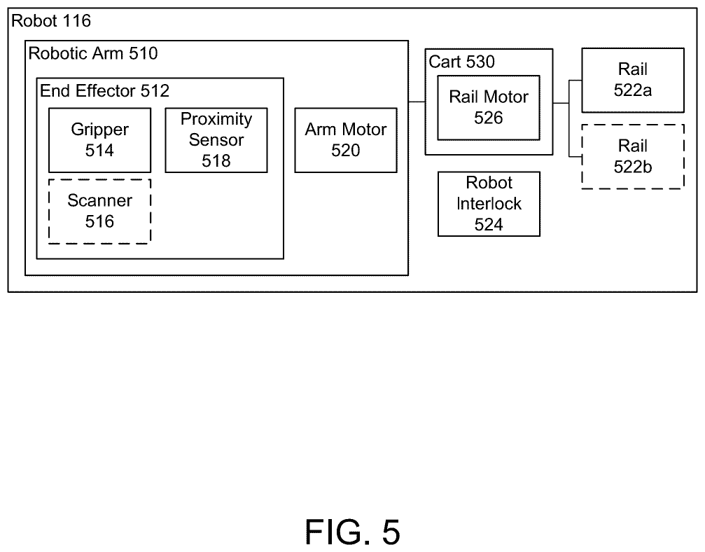

FIG. 6 shows an illustrative variation of a robot 600. The robot 600 may comprise a robotic arm 610. The robotic arm 610 may comprise multiple motors (e.g., two, three, four, five, six, or more). Identified in FIG. 6 are a first arm motor 620a, a second arm motor 620b, and a third arm motor 620c. In some variations, the actuation of one arm motor may adjust the position of at least one other arm motor. In some variations, the actuation of one arm motor may not adjust the position of any other arm motor. The robotic arm 610 may further comprise an end effector 612 coupled to a distal end of the robotic arm. The actuation of one or more of the arm motors 620a, 620b, 620c may move the end effector. The robot arm 610 may be configured to move the end effector 612 to any position within the internal zone. In some variations, the robotic arm 610 may be configured to move the end effector 612 to any position within or between any of the reagent vault, JIT feedthrough, waste unit, AIS port, and AIS instrument. Actuation of one or more of the arm motors 620a, 620b, 620c may be controlled by a controller. In some variations, actuation of one or more of the arm motors 620a, 620b, 620c may occur automatically and without input from a user.

The robot 600 may be coupled to the cart 630. The cart 630 may comprise a substantially flat surface to which the robot 600 is fixedly or removably coupled. The robot 600 may be coupled to the cart 630 via at least one mechanical fastener such as, for example, at least one screw, weld, adhesive, friction fit, or any other suitable mechanism. The cart 630 may be configured to move along each of a first rail 622a and a second rail 622b. For example, the cart may comprise at least one wheel configured to engage with each of the rails 622a, 622b. In some variations, the cart 530 may be coupled to each of the rails 622a, 622b via rollers, linear bearings, continuous tracks, magnets, or any other mechanical mechanism. Each of the rails 622a, 622b may comprise corresponding features configured to engage with the cart 630. For example, each of the rails 622a, 622b may comprise at least one indent, groove, and/or depression.

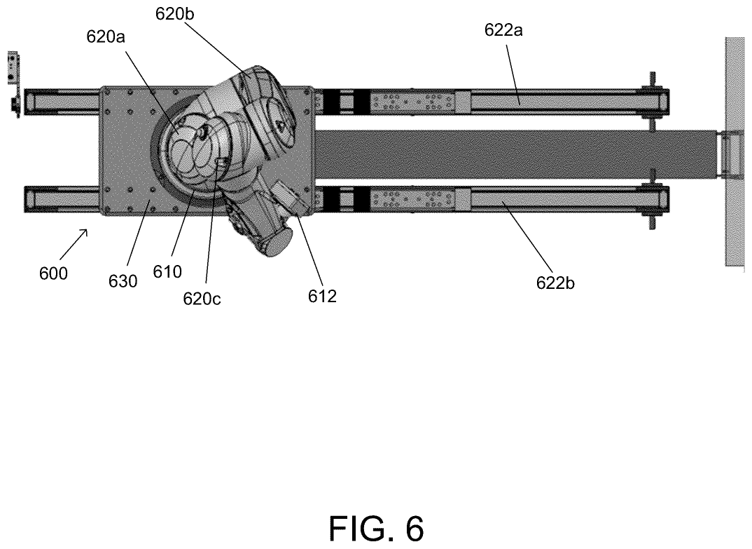

FIGS. 7A-C show an illustrative variation of an end effector 712 and how that end effector may be used to engage fluid devices, such as SLTD 720. For example, the end effector 712 may be configured to couple to a robotic arm on one side and an SLTD on another side. The end effector 712 may comprise a gripper, pin, or other engagement feature configured to engage with a corresponding index opening or other engagement feature of an SLTD. In some variations, the end effector 712 may comprise a first gripper 714a and a second gripper 714b. The gripper may be any suitable gripper or engagement feature, for example, a protrusion, a magnetic coupling, or the like. In some variations, the index opening of the SLTD 720 may comprise a first index opening 710a and a second index opening 710b. The index openings 710a, 710b may be holes, grooves, indents, hooks, or any other engagement feature that corresponds with the engagement feature of the end effectors.

In FIG. 7A, grippers 714a, 714b are shown in a first uncoupled configuration. The first configuration may comprise the grippers 714a, 714b separated from each other by a first distance. The grippers 714a, 714b may be in the first configuration prior to engaging the SLTD 720. In FIG. 7B, the end effector 712 is shown contacting the SLTD via movement of the robot. As shown, the grippers 714a, 714b are inserted within the index openings 710a, 710b of the SLTD 720. In FIG. 7C, the grippers 714a, 714b are moved to a second engaged configuration. The grippers 714a, 714b may transition between the first and second configurations via actuation of a motor (not shown) within the end effector 712. When the grippers 714a, 714b are engaged with the index openings 710a, 710b in the second configuration, the end effector is effectively coupled to the SLTD such that the SLTD may be securely transferred by the robot. In this way, the robot may then pick up and move the SLTD from one location within the workcell to another location within the workcell. Again, while the engagement features of the end effector and SLTD shown in FIGS. 7A-7C are protrusions and openings, any suitable engagement features may be used.

### B. Reagent Vault System

i. Reagent Vault

As described above, the workcell may comprise a reagent vault system. The reagent vault system may comprise one or more reagent vaults that may be accessed by either a human user or a robot. The reagent vaults are configured to contain multiple SLTDs of multiple sizes in a controlled environment, sometimes for minutes, hours, or multiple days. The SLTDs may or may not contain a reagent. In some variations the SLTDs contain one or more cell products, and in some variations the SLTDs are empty and used for waste or other by-products of cell processing.

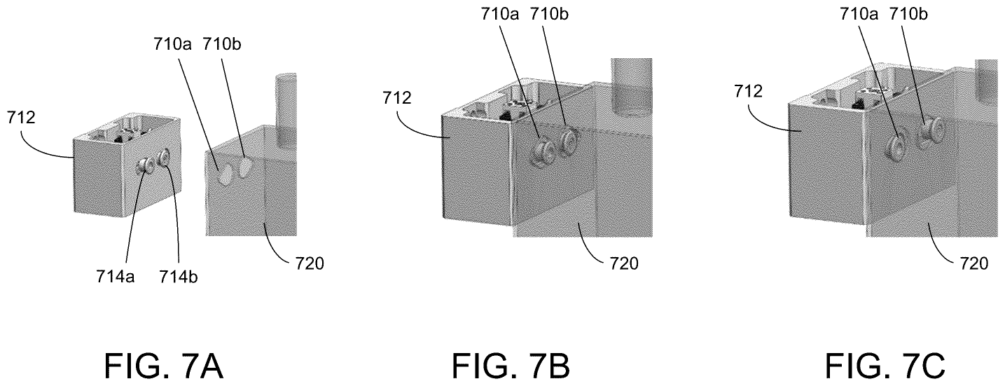

FIG. 8 provides a schematic block diagram of an exemplary reagent vault system that may be used with the systems and methods described here. As shown there, reagent vault system 110 comprises a reagent vault 112a. The reagent vault 112a may comprise a carousel 810a, a scanner system 812a, and a sensor system 820a. The carousel 810a may further comprise at least one SLTD slot configured to contain at least one SLTD. The carousel 810a may be configured to rotate (e.g., around a central axis via input from a user or a motor).

The scanner system 812a may be configured to measure at least one feature on an SLTD. For example, in some variations, the scanner system 812a may comprise a barcode reader configured to read a barcode on an outer surface of an SLTD. In some variations, the scanner system 812a may comprise a plurality of sensors. For example, some sensors may be configured to identify SLTD slots of a carousel 810a that are empty or slots in the carousel 810a that contain an SLTD. In some embodiments, one or more sensors can be a laser distance sensor. The scanner system 812a may or may not be attached to the carousel and move independently from the carousel. In some variations, the carousel 810a may rotate while the scanner system 812a remains stationary. The sensor system 820a may comprise any number of sensors configured to sense, detect, and/or measure any number of parameters within the reagent vault system. For example, the sensor system 820a may be configured to measure one or more of a temperature, a pressure, a humidity, a hydrogen peroxide level, or the like, within the reagent vault system or reagent vault 112.

The reagent vault 112 may further comprise an outer door 816a and an inner door 818a. The outer door 816a may be configured to open into an environment external to the workcell. For example, the outer door 816a may open into a laboratory or other cleanroom environment. The outer door 816a may be opened or closed by a user, or may be opened or closed automatically by signals sent by the controller. The inner door 818a may be configured to open into an environment within the workcell, such as, for example, the internal zone. The inner door 818a may be opened or closed by a robot or a user. In some variations, the inner door 818a is opened by a robot based on signals sent by the controller.

The sensor system 820a may further comprise a door sensor that measures the status of the outer door 816a and inner door 818a. In this variation, opening one of the inner door 818a and outer door 816a may cause an interlock to be engaged on the opposite door. For example, if the outer door 816a is opened, an interlock may engage the inner door 818a and prevent the inner door 818a from being opened. Similarly, if the inner door 818a is opened, an interlock may engage the outer door 816a and prevent the outer door 816 from being opened. In this way, sterility of the workcell environment is more easily attained. In addition, providing an interlocking door can enhance user safety (e.g., keep users away from sterilants, as well as from the robotic systems within the workcell). The sensor system 820a may be coupled with the interlocks of the inner door 818a and outer door 816a such that the interlocks engage automatically based on a sensor reading. In some variations, both doors may be locked at the same time. In some variations, both the inner door 818a and outer door 816a may be opened at the same time, e.g., during cleaning or repair.

The reagent vault 112a may further comprise a refrigeration unit 824a. The refrigeration unit 824a may be configured to maintain a temperature within a desired temperature range within the reagent vault 112a. For example, the temperature may be maintained at approximately 4 degrees C. In some variations, the temperature to be maintained is set as a threshold temperature and when the temperature deviates from the threshold temperature, a controller 822a may be engaged to try to maintain the threshold temperature. In some embodiments, the threshold temperature may be within a temperature range (e.g., between about 2 degrees C. and about 8 degrees C.). In some variations, the temperature range may be between about 4 degrees C. and about 8 degrees C., about 3 degrees C. and about 5 degrees C., about 2 degrees C. and about 6 degrees C., about 0 degrees C. and about 10 degrees C., about 0 degrees C. and about 12 degrees C., about 0 degrees C. and about 14 degrees C., about 0 degrees C. and about 16 degrees C., about −2 degrees C. and about 10 degrees C., about −2 degrees C. and about 8 degrees C., about −4 degrees C. and about 10 degrees C., about −4 degrees C. and about 8 degrees C., or about −4 degrees C. and about 14 degrees C.

When the threshold temperature cannot be maintained, the controller 822a may be engaged to provide one or more alerts (e.g., audible, visual, etc.) to the user of the workcell or to one or more displays of the workcell. The threshold temperature may set to less than about 4 degrees C., such as about 3 degrees C., about 2 degrees C., about 1 degree C., about 0 degrees C., about −2 degrees C., about −4 degrees C., about −6 degrees C., about −8 degrees C., or colder. The refrigeration unit 824a may be operatively coupled to the sensor system 820a such that a measurement measured by the sensor system 820a determines a response by the refrigeration unit 824a. For example, if a temperature sensor of the sensor system 820a measures a temperature value outside a target temperature range (or in some embodiments, above a threshold temperature), the refrigeration unit 824a may be powered on, set to output a lower temperature, and/or a refrigerant flow rate increased. In another example, if a temperature sensor of the sensor system 820a measures a temperature value below the threshold temperature, the refrigeration unit 824a may be powered off, set to output a higher temperature, and/or a refrigerant flow rate decreased.

As noted above, the reagent vault 112a may further comprise the controller 822a (also referred to as a reagent vault controller). The controller 822a may comprise a display, a communication device, a processor, and a memory. The controller 822a may communicate with any component within the reagent vault 112a via the communication device. For example, the controller 822a may be configured to open the inner door 818a and outer door 816a. The controller 822a may also be configured to control the refrigeration unit 824a. In some variations, a user may input a target temperature into the controller 822a and the refrigeration unit 824a may be adjusted by the controller to maintain the target temperature within the reagent vault 112a. The controller 822a may be electrically connected to the controller of the workcell. The controller 822a may be configured to send one or more of commands, sensor measurements, and component statuses to the workcell controller. The workcell controller may be configured to control controller 822a, but need not be so configured. One or more of the workcell controllers and reagent vault controller 822a may be configured to activate or otherwise engage one or more of the sensor, scanner, interlocks, alarms, robot, a combination thereof, and the like.

The reagent vault 112a may further comprise a sterilant distributor 814a. The sterilant distributor 814a may be configured to sterilize and/or decontaminate the reagent vault 112a, or any portion or component thereof or therein. In some variations, the sterilant distributor 814a comprises an outlet coupled to the sterilant source of the workcell. For example, the outlet may comprise a sterilization nozzle fluidically coupled to the sterilant source via tubing. In some variations, the sterilant distributor comprises an ultraviolet light source. In some variations, the decontaminant or sterilant may comprise one or more of ionized hydrogen peroxide, vaporized hydrogen peroxide, chlorine dioxide, or isopropyl mist. For example, the sterilization nozzle of the sterilant distributor 814a may create a mist of ionized hydrogen peroxide. In some variations, the sterilant distributor 814a distributes a sterilant and/or decontaminant to substantially all surfaces of substantially all components within the reagent vault 112a. The reagent vault 112a may be sized and shaped, at least partially, based on the effective sterilant distribution.

The sterilant distributor 814a may conduct a decontamination cycle within the reagent vault 112a based on a predetermined schedule, or may be triggered on-demand. For example, a decontamination cycle may be conducted once per 24-hour period, once per 12-hour period, once per 6-hour period, and the like. In some variations, a decontamination cycle may be triggered based on the occurrence of at least one predetermined event, for example, the opening or closing of the inner or outer doors, or the timing of the cell processing steps and/or schedule. For example, a user opening and subsequently closing an outer door 816a of the reagent vault 112a may trigger a decontamination cycle after the outer door 816a has been closed and locked. In another example, a robot opening and subsequently closing an inner door 818a of the reagent vault 112a may result in a decontamination cycle occurring after the inner door 818a has been closed. Similarly, decontamination cycles may be triggered based on the schedule, or based on particular steps of any given cell processing workflow. A decontamination cycle may last for a predetermined duration. In an exemplary embodiment, the decontamination cycle may last for one hour. The decontamination cycle may last half an hour, two hours, three hours, or four hours. In some variations, the decontamination cycle may last for as long as is required for the external surfaces within the reagent vault 112a to reach a desired level of decontamination. The quantity or intensity of the decontaminant distributed may be constant throughout the duration of the decontamination cycle, or may vary. When interlocks are used, they may stay engaged until the decontamination cycle is completed.

The reagent vault 112a may further comprise a spill tray 826a. The spill tray 826a may be configured to capture a liquid that has accidentally been released from one or more SLTDs within the reagent vault 112a. The spill tray 826a may be configured to contain about 1 L of fluid. In some variations, the spill tray 826a may be configured to contain other volumes of fluids, such as about 1.5 L, about 2 L, about 2.5 L, and about 3 L of fluid. The spill tray 826a may comprise a spill sensor 828a to help determine the amount of fluid within the spill tray so that the spill tray may be emptied prior to overflowing. The spill sensor may be operatively coupled to the sensor system 820a and/or the controller 822a.

As discussed above, the reagent vault system 110 may comprise any number of reagent vaults. For example, the reagent vault system may comprise at least one, at least two, at least three, at least four, at least five, etc. reagent vaults. In the variation shown in FIG. 8, three reagent vaults 112a, 112b, and 112c are shown. In some embodiments, each reagent vault may have the same configuration as every other reagent vault, while in other embodiments, the reagent vaults can have a different configuration. For example, reagent vault 112a may comprise a carousel configured to hold multiple SLTDs and reagent vaults 112b, 112c may not have a carousel. In some variations, reagent vault 112a may be in active use and reagent vaults 112b, 112c may be powered off. For example, one of the reagent vaults 112a, 112b, 112c may be shut down for maintenance such as cleaning or repairs and the remaining reagent vaults 112a, 112b, 112c may continue to be used normally.

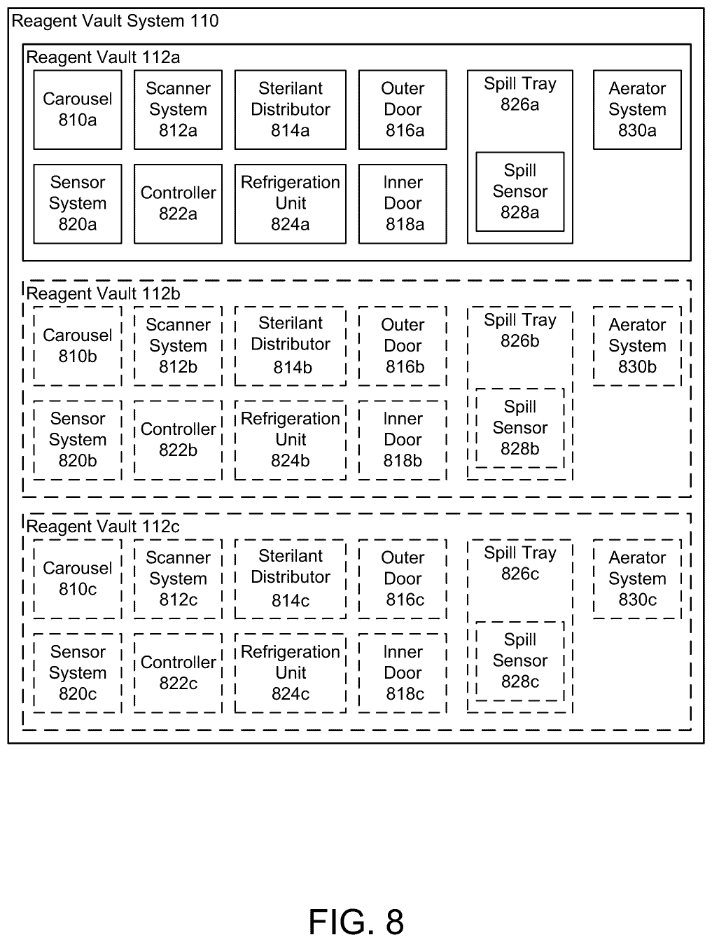

FIGS. 9A and 9B show an exemplary variation of a reagent vault. As shown there, the reagent vault may comprise a carousel 910. The top of the carousel may be coupled to a support bracket 950, which may in turn be coupled to a sidewall of the reagent vault. The support bracket 950 may provide an offset to help ensure the rotation of the carousel 910 is not inhibited. In some variations, the carousel 910 is coupled directly to a ceiling of the reagent vault or coupled via some other support or offset. In some embodiments, the carousel can be removably mounted within the reagent vault.

The reagent vault may further comprise a sterilant distributor 914. In some variations, the sterilant distributor 914 may be configured to distribute an ionized hydrogen peroxide solution via, for example, a sterilization nozzle. The sterilant distributor 914 may be positioned at any desirable location within the reagent vault, and in FIG. 9A is shown located toward the bottom of the carousel 910. In some variations, the sterilant distributor 914 may be fixed in a single location. In some variations, the sterilant distributor 914 may be configured to move positions within the reagent vault. The sterilant distributor 914 may be positioned adjacent to a spill tray 926 so that the spill tray 926 can capture any leaked or excess fluid.

The reagent vault may further comprise an aerator system configured to filter the environment within the reagent vault. For example, as shown in FIG. 9, the aerator system 930 may be configured to perform an aeration cycle to help remove sterilant, particulates, or other decontaminants introduced to the reagent vault 912. The aerator system 930 may comprise a fan filter unit (FFU) 960 fluidically coupled to one or more filters. The FFU 960 may comprise a fan or a blower configured to move air through the one or more filters. The one or more filters may comprise a HEPA filter, an activated carbon filter, a catalyst, and a dryer. The HEPA filter, which may be replaceable, may be configured to remove particulates from the air within the reagent vault. The activated carbon filter, which may be replaceable, may be configured to remove particulates as well as sterilant from the air within the reagent vault. The catalyst may be configured to remove sterilant from the air within the reagent vault. The dryer may be configured to remove humidity and hydrogen peroxide, if present, from the air within the reagent vault.

The aerator system 930 may operate as a closed loop system or an open loop system. In the open loop system, air may be drawn into the reagent vault from an external environment (e.g., within the workcell or a laboratory environment external to the workcell), combined with air within the reagent vault, filtered via one or more filters of the aerator system 930, and expelled back into the external environment. The open loop system may advantageously filter air within the reagent vault and air external to the reagent vault, which may prevent further particulates from entering the reagent vault if a reagent vault door is opened. In the closed loop system, air may be drawn from the reagent vault, filtered via the aerator system 930, and expelled back into the reagent vault. In some embodiments, the closed loop system may advantageously maintain a colder set air temperature within the reagent vault than the open loop system.

The aerator system 930 may be configured to operate simultaneously with the sterilant distributor 914 or may not be so configured. In some variations, the aerator system 930 may be configured to operate after the completion of a decontamination cycle performed by the sterilant distributor 914. The aerator system 930 may be in communication with a gas sensor 920 (e.g., a hydrogen peroxide sensor). The sensor may be used to measure gas to help determine the duration of an aeration cycle. For example, the gas sensor 920 may measure a first value of a concentration of hydrogen peroxide that is greater than a predetermined safety threshold, which may activate the aerator system 930. The gas sensor 920 may then measure a second value of a concentration of hydrogen peroxide that is lower than a predetermined safety threshold, which may deactivate the aerator system 930.

The reagent vault may further comprise components configured to control the operation of any of the components of the reagent vault. For example, the reagent vault may comprise a controller 922. The controller 922 may be configured to control operation of one or more of the carousel 910, the aerator system 930, the sterilant distributor 914, and any other component within the reagent vault. Any of the sensors within the reagent vault may be configured to input into the controller 922. The controller may be located at any suitable location or position within the reagent vault. In the variation shown in FIG. 9B, the controller 822 is positioned in a storage area underneath the carousel 910.

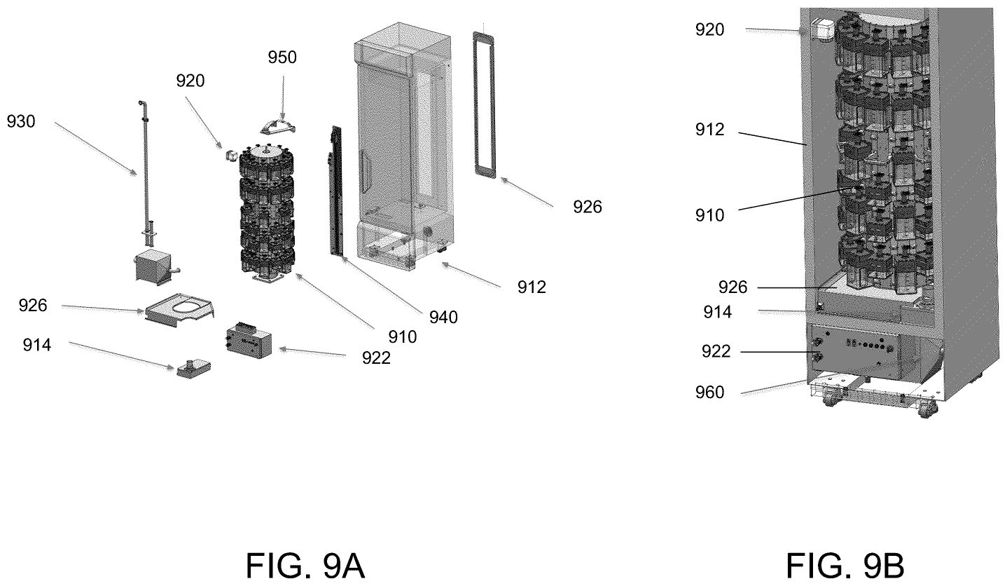

FIG. 10 provides a schematic block diagram of an exemplary sensor system 820 for use within the reagent vault variations described herein. The sensor system 820 may comprise any number of sensors for detecting any number of desirable parameters. In the variations shown in FIG. 10, sensor system 820 comprises liquid temperature sensor 1010, pressure sensor 1020, air temperature sensor 1030, hydrogen peroxide sensor 1040, particulate sensor 1050, door status 1060, and relative humidity sensor 1070. The liquid temperature sensor 1010 may comprise a temperature sensor placed within a liquid. For example, in some variations, the liquid temperature sensor 1010 may be placed within glycol contained in a bottle. Submerging at least a portion of the liquid temperature sensor 1010 in a liquid may reduce fluctuations in the measurements as compared to, for example, measurements from an air temperature sensor. In some variations, liquid temperature sensor 1010 may comprise more than one temperature sensor, which may be placed in different locations, or be different liquid temperature sensors. When more than one temperature sensor is used, the temperature of multiple locations within the reagent vault and/or a SLTD may be measured and/or monitored. In some variations, the liquid temperature sensor 1010 may be configured to communicate with the workcell controller and/or the reagent vault controller. As described above, the temperature sensor and/or controller(s) may be configured to help alert a user when the liquid temperature sensor 1010 measures outside of a specified temperature range and/or greater than a threshold temperature by triggering an alarm. The alarm may be an audible, visual, or other alarm. In some variations, the threshold temperature may be approximately 4 degrees C. For example, a liquid temperature sensor measurement above 4 degrees C. may indicate that the reagents within any SLTDs stored in the reagent vault may be unsuitable for use and may be discarded. In some variations, the liquid temperature sensor 810 comprises a plurality of liquid temperature sensors placed in a plurality of locations within the reagent vault.

The pressure sensor 1020 may comprise an absolute pressure sensor or a differential pressure sensor. More than one pressure sensor may be used, and when more than one pressure sensor is used, they need not be of the same type or configuration. As described above, the pressure sensor and/or controller(s) may be configured to help alert a user when the pressure sensor 1020 measures a pressure above or below a threshold pressure by triggering an alarm. For example, a first pressure sensor and a second pressure sensor may be configured to measure the absolute pressure within the reagent vault. In another example, a third pressure sensor may be configured to measure a pressure differential between the internal environment of the reagent vault and the internal zone of the workcell. In a further example, a fourth pressure sensor may be configured to measure a pressure differential between the internal environment of the reagent vault and the external environment outside of the workcell. In some variations, the reagent vault may be maintained at a slightly higher pressure than either of the internal zone and the external environment. For example, the reagent vault may be maintained at about 1 psi greater than either of the internal zone and the external environment. In this way, a positive pressure differential is maintained to help facilitate airflow from within the reagent vault to the internal zone when the inner door is opened. Similarly, a positive pressure differential may facilitate airflow from within the reagent vault to the external environment when the outer door is opened. The airflow from within the reagent vault to the external environment may help prevent contaminants from entering the reagent vault when one or more the outer door and inner door are opened. In some variations, the pressure sensor 1020 may be configured to communicate with the workcell controller and/or the reagent vault controller. In some variations, the pressure sensor 1020 comprises a plurality of pressure sensors placed in a plurality of locations within the reagent vault. In some variations, at least one pressure sensor 1020 may be configured to determine a leak rate of the reagent vault. A leak rate associated with the reagent vault may be calculated by continuously or semi-continuously measuring a pressure within the reagent vault and dividing the change in pressure by a specified period of time. For example, the pressure sensor 1020 may measure a first pressure value at a first time and a second pressure value at a second time. The difference between the first pressure value and the second pressure value, divided by the difference between the first time and the second, may determine a leak rate. The calculated leak rate may be used to determine whether or not a decontamination cycle may be safely performed. If a leak is determined, one or more interlocks may be triggered and/or a decontamination cycle may be stopped or unexecuted to ensure the safety of operating personnel. If there is no leak detected or the leak rate is otherwise acceptable, a decontamination cycle may proceed.

The air temperature sensor 1030 may be configured to measure an air temperature within the reagent vault. In some variations, the air temperature sensor 1030 may comprise more than one sensor. In variations where more than one sensor is used, the sensors need not be the same and need not be placed in the same location within the reagent vault. For example, a first air temperature sensor may be placed in a first location within the reagent vault, and a second air temperature sensor may be placed in a second location within the reagent vault. The first location may be, for example, near a floor of the reagent vault and the second location may be, for example, near a ceiling of the reagent vault. In this way, the air temperature within the reagent vault may be determined, which may be useful in determining the duration of a decontamination cycle. Generally speaking, a duration of a decontamination cycle may be inversely proportional to temperature such that the decontamination cycle may need to last longer as the air temperature decreases. In some variations, the air temperature sensor 1030 may be configured to communicate with the workcell controller and/or the reagent vault controller. In this way, a user may be alert when deviations in air temperature sensor measurements are outside of a pre-set temperature range and/or exceed a particular threshold temperature, and an alarm may be triggered. In some variations, the threshold temperature may be approximately 4 degrees C. The alarm is an audible alarm, a visual alarm, a virtual alarm, or a combination thereof. In some variations, the air temperature sensor 1030 comprises a plurality of air temperature sensors placed in a plurality of locations within the reagent vault.

The sensor system may also comprise a hydrogen peroxide sensor 1040 configured to measure a quantity of hydrogen peroxide (H₂O₂) within the reagent vault. For example, hydrogen peroxide may be introduced to the reagent vault during a decontamination process of at least one SLTD, and the hydrogen peroxide sensor may be used to determine that adequate decontamination has occurred or that no more residual hydrogen peroxide remains after the decontamination process. The hydrogen peroxide sensor 1040 may comprise a low H₂O₂ concentration detector. In some variations, the hydrogen peroxide sensor 1040 may comprise a high H₂O₂ concentration detector. In some variations, the hydrogen peroxide sensor 1040 comprises more than one sensor. In these variations, the sensors need not be of the same type or configuration nor placed within the same location within the reagent vault. In some variations, the hydrogen peroxide sensor 1040 may be configured to communicate with the workcell controller and/or the reagent vault controller. In some variations, the hydrogen peroxide sensor 1040 may be configured to communicate with the inner door and/or outer door of the reagent vault. For example, the hydrogen peroxide sensor 1040 may communicate with the controller to help prevent the opening of one or more of the doors if the hydrogen peroxide sensor 1040 measures a quantity (i.e., concentration) of H₂O₂ that exceeds a predetermined threshold. The predetermined threshold may be based on a level safe for human exposure, such as 1 part per million (ppm) of H₂O₂ averaged over an 8-hour time period.

The sensor system may also comprise a particulate sensor 1050 configured to measure a quantity and/or a size of particulates within the reagent vault. For example, the particulate sensor 1050 may comprise a PM2.5 sensor. The particulate sensor 1050 may be placed in any location within the reagent vault 112, and more than one particulate sensor may be used. The particulate sensor 1050 may be useful in evaluating compliance with quality assurance objectives. One or more measurements from the particulate sensor 1050 may be used to determine the air quality within the reagent vault. When more than one particulate sensor is used, they need not be of the same type and/or configuration and need not be placed within the same location within the reagent vault. The particulate sensor 1050 may be configured to communicate with the workcell controller and/or the reagent vault controller. In some variations, the particulate sensor 1050 comprises a plurality of particulate sensors placed in a plurality of locations within the reagent vault.

The sensor system may also comprise a door status sensor 1060 configured to measure the status of at least one door of the reagent vault. The door status sensor 1060 may comprise more than one sensor, and in variations when more than one sensor is used, they need not be of the same type and/or configuration and need not be placed in the same location within the workcell. The door status sensor 1060 may comprise an optical sensor, one or more magnets, a pressure sensor, or an electrical circuit. For example, in one variation, a first door status sensor comprising an optical sensor may be located on or near an inner door of the reagent vault, and a second door status sensor comprising an optical sensor may be located on or near an outer door of the reagent vault. There may be an optical sensor receiver positioned opposite each optical sensor. The optical receiver may receive a signal from the optical sensor if the corresponding door is closed, and the receiver may not receive a signal if the corresponding door is open. In this way, an optical measurement from each sensor may detect when the doors are opened or closed. In another example, a first magnet may be located on or near an inner door of the reagent vault, and a second magnet may be located on or near an outer door of the reagent vault. There may be a magnet receiver positioned opposite each of the first and second magnets. Each magnet receiver may receive a signal from the respective magnet if the corresponding door is closed, and the magnet receiver may not receive a signal if the corresponding door is open. In this way, a magnetic measurement from each sensor may detect when the respective doors are opened or closed.

The door status sensor 1060 may be configured to communicate with the workcell controller and/or the reagent vault controller to engage one or more interlocks of the reagent vault. For example, if a door status sensor coupled to an inner door detects that it has been opened when it should not be, the interlock can be engaged on the outer door to prevent the outer door from being opened. In another example, if a door status sensor detects that the outer door has been opened when it should not be, the workcell and/or reagent vault controller may engage an interlock to prevent the inner door from being opened.

The sensor system may also comprise a relative humidity sensor 1070 configured to measure the humidity within the reagent vault relative to one or more of the internal zone and the external environment. One or more measurements by the relative humidity sensor 1070 may be used to determine the duration and/or efficacy of a decontamination cycle. For example, a relatively humid environment may result in a relatively longer decontamination cycle. The relative humidity sensor 1070 may be in communication with the workcell controller and/or the reagent vault controller. The relative humidity sensor 1070 may be placed in any location within the reagent vault, and any number of relative humidity sensors may be used. The relative humidity sensor 1070 may comprise a plurality of relative humidity sensors placed in a plurality of locations within the reagent vault.

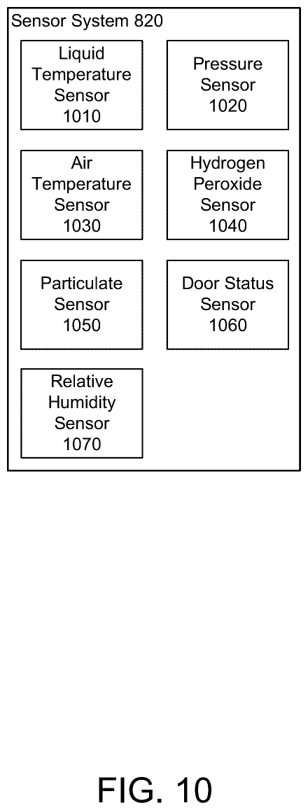

FIG. 11 shows an exemplary exoskeleton or outer housing of a reagent vault. Shown there are various sensors and locations. For example, the reagent vault may comprise a first air temperature sensor 1030a in a first location on an internal surface of a sidewall of the reagent vault and a second air temperature sensor 1030b in a second location on an internal surface of a sidewall of the reagent vault. In some variations, the first location may be near a top of the reagent vault and the second location may be near a bottom of the reagent vault. The reagent vault may further comprise a relative humidity sensor 1070 in a third location on an internal surface of a sidewall of the reagent vault. In some variations, the third location may be substantially equidistant between the top and the bottom of the reagent vault. In some variations, the sensors 1030a, 1030b, and 1070 may be in the same location on an inner surface of a sidewall of the reagent vault.

The reagent vault may comprise additional components configured to increase the flexibility of the cell processing system. In some variations, the reagent vault may comprise one or more wheels 1112a, 1112b, 1112c, and 112d coupled to an external surface of the bottom of the reagent vault. In some variations, While four wheels are shown in this variation, any number of wheels may be used. Any or all of the wheels may be lockable to prevent movement during use.

The reagent vault may comprise additional components configured to control air flow within the reagent vault. For example, the reagent vault may comprise a fan 1110. The fan 1110 may be coupled to an internal surface of the top of the reagent vault. In some variations, the fan 1110 may be configured to direct air over one or more condensing coils. The condensing coils may be configured to lower a temperature of the air passing over the condensing coils. The lower temperature air may then flow back into the reagent vault. In this way, the fan 1110 may increase the efficacy of the condensing coils by providing a greater volume of air that may be cooled and subsequently flowed back into the reagent vault.

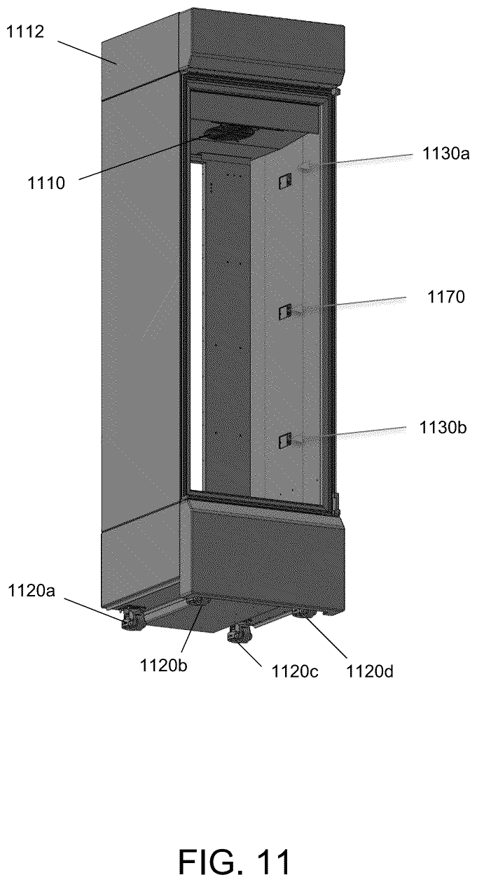

FIG. 12 shows a schematic block diagram of a carousel 810 for use within a reagent vault 112. The carousel 810 may comprise a column 1250a. The column 1250a may comprise an SLTD slot 1242a configured to receive at least one SLTD 1212a. The slot 1242a may comprise at least one index feature configured to align with a corresponding index feature of the SLTD. In this way, each SLTD may only be loaded onto the carousel 810 in a predetermined orientation. For example, an SLTD may not be loaded onto the carousel 810 if the index features are not aligned properly. The column 1250a may comprise any number of SLTD slots, for example, 1242a-1242g. In some variations, the column 1250a comprises 5, 6, 7, 8, 9, 10, 15, 20, 25, 30, 35, 40, 45, 50, 55, or even more SLTD slots. An SLTD may be loaded into any available (e.g., empty) SLTD slot. In this way, the loading process may be referred to as random. The SLTD slots may each be configured to engage with an SLTD of any size, and multiple different sized SLTDs may be loaded into a single carousel. For example, the SLTD may comprise a storage volume of approximately 0.5 L. In a further example, the SLTD may comprise a storage volume of approximately 1 L. The carousel 810 may be configured to receive an SLTD that contains any suitable cell processing fluid or mixture (e.g., reagents, cells, etc.). In some variations, the carousel 810 may be configured to receive an SLTD that is empty.

The carousel 810 may comprise a plurality of columns, e.g., a first column 1250a and a second column 1250b. The second column 1250b may comprise at least one SLTD slot 1242a′ configured to receive at least one SLTD 1212a′. Any number of columns may be used as desirable. In some variations, there are 12 columns. In some variations, there are 3 columns, 4 columns, 5 columns, 6 columns, 7 columns, 8 columns, 9 columns, 10 columns, 11 columns, 13 columns, 14 columns, or 15 columns.

The carousel 810 may further comprise a rotating axle 1230 and a carousel motor 1232. The rotating axle 1230 may comprise a pole spanning from a bottom of the carousel 810 to a top of the carousel 810. Each column may be coupled to the rotating axle 1230. The carousel motor 1232 may also be coupled to the rotating axle 1230. The carousel motor 1232 may be configured to rotate the rotating axle 1230 at a predetermined rate. The motor 1232 may be operatively disengaged based on an input signal from the workcell and/or reagent vault controller. For example, the controller(s) may disengage the motor from the rotating axle 1230 when a user opens an outer door of the reagent vault. In this way, the user may easily rotate the carousel 810 manually. In another embodiment, the carousel motor 1232 may stay engaged with the rotating axle 1230 when a robot opens an inner door of the reagent vault. The carousel 810 may be rotated such that an empty SLTD slot 1242a or 1242a′ is brought proximate to one of the outer or inner doors of the reagent vault, within which an SLTD may be placed. The carousel 810 may be rotated such that a specific SLTD is brought proximate to one of the outer door or inner door of the reagent vault. For example, a user may select a specific SLTD via the workcell and/or reagent vault controller(s) and the carousel 810 may rotate so that the selected SLTD is brought proximate to the outer door to be accessed by the user. In some variations, any SLTD may be accessed (e.g., removed and/or replaced) from the carousel 810 by the user. In this way, access by the user may be referred to as random. In another example, the workcell may autonomously select a specific SLTD and the carousel 810 may rotate so that the selected SLTD is brought proximate to the inner door to be accessed by the robot. In some variations, any SLTD may be accessed (e.g., removed or replaced) from the carousel 810 by the robot. In this way, the access by the robot may be referred to as random.

The carousel within the reagent vault may comprise a plurality of columns. Each column may comprise a plurality of SLTD slots, such as 5, 6, 7, 8, 9, 10, 11, 12, 13, 14, 15, or even more SLTD slots. The plurality of SLTD slots may be arranged in a vertical line (i.e., one SLTD slot above another SLTD slot, and so on) or multiple vertical lines (thereby creating an array of SLTD slots). An SLTD with any storage volume may be loaded into any available SLTD slot within which the SLTD may physically fit. For example, an SLTD with a storage volume of 0.5 L may fit into an SLTD slot above, below, or next to an SLTD with a storage volume of 1 L. In this way, a plurality of SLTDs contained on a single column may vary in size. For example, one or more SLTDs on a given column may comprise a storage volume of 1 L, and one or more SLTDs on the same carousel may comprise a storage volume of 0.5 L.

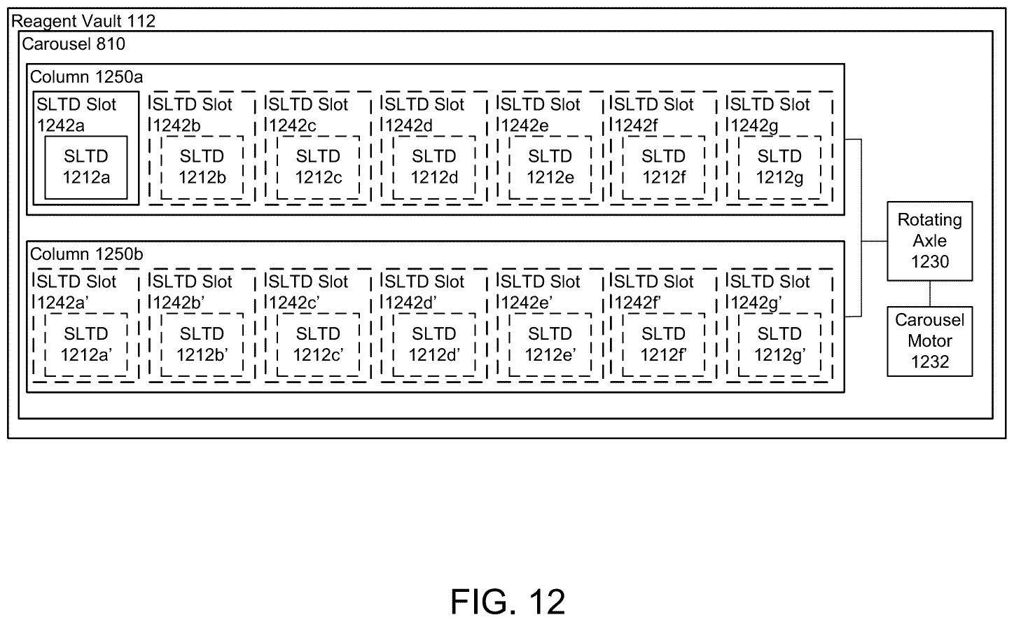

FIG. 13A shows an exemplary variation of a carousel 1310. The carousel 1310 may comprise a column 1350a. The column 1350a may comprise a plurality of SLTD slots, for example a first SLTD 1342a, a second SLTD 1342b, a third SLTD 1342c, a fourth SLTD 1342d, and a fifth SLTD 1342e. Each SLTD slot may be configured to receive one SLTD. In some variations, the column 1350 may be configured to receive five SLTDs, for example, 1312a, 131b, 1312c, 1312d, and 1312e. SLTD 1312a, 131b, 1312c, 1312d, and 1312e may be of the same size (e.g., capable of holding the same volume and be of the same general shape) as every other SLTD. For example, the SLTDs may each be configured to contain a volume of 1 L. In other variations, the SLTDs are not of the same size, and some are configured to contain a volume of 0.5 L while others are configured to contain a volume of 1 L. In some variations, the remaining SLTD slots of the carousel 1310 are left empty. The carousel 1310 may further comprise a rotating axle 1330. A top portion of the rotating axle 1330 may extend from atop of the carousel 1310. A bottom portion of the rotating axle 1330 may extend from a bottom of the carousel 1310. The bottom portion of the rotating axle 1330 may be coupled to the carousel motor 1332.

FIG. 13B shows an exemplary portion of one variation of a carousel 1310. The carousel 1310 may comprise one or more column, such as column 1350b. In this variation, the column 1350b comprises a first SLTD slot 1342a′, a second SLTD slot 1342b′, a third SLTD slot 1342′, a fourth SLTD slot 1342d′, a fifth SLTD slot 1342e′, a sixth SLTD slot 1342f, and a seventh SLTD slot 1342g′. Each SLTD slot may be configured to receive one SLTD. The SLTDs shown in FIG. 13B may comprise a smaller volume than the variation shown in FIG. 13A. For example, the SLTD may each comprise a storage volume of 0.5 L. In some variations, each SLTD slot shown in FIG. 13B may also be configured to receive an SLTD of any other dimension or storage volume, such as a storage volume of 1 L.

FIG. 13C shows a top view of an exemplary variation of a carousel 1310 showing multiple columns. For example, shown there is a first column 1350a, a second column 1350b, a third column 1350c, a fourth column 1350d, a fifth column 1350e, a sixth column 1350f, a seventh column 1350g, an eighth column 1350h, a ninth column 1350i, a tenth column 1350j, an eleventh column 1350k, and a twelfth column 13501. Again, it should be understood that any number of columns may be used. Each column may comprise one or more SLTD slots as described above. In some variations, the carousel comprises 12 columns having seven SLTD slots each. Each SLTD slot may be configured to receive an SLTD. For example, shown there is an SLTD 1313a coupled to an SLTD slot of column 1350a, an SLTD 1313b coupled to an SLTD slot of column 1350b, and so on.

FIG. 13D shows an exemplary variation of a carousel 1310 having multiple SLTDs loaded thereon. The carousel 1310 may comprise multiple columns, e.g., a first column 1350a and a second column 1350b. The column 135a may be empty and column 1350b may comprise a plurality of SLTDs, which may be of the same or different size from the other SLTDs. The carousel 1310 may further comprise a support bracket 1360. The support bracket 1360 may be coupled to a top portion of the rotating axle of the carousel. The carousel 1310 may be in close proximity to a scanner system 1372. The scanner system 1372 may comprise a scanner 1374. The scanner system 1372 may be configured to perform at least one measurement of the carousel 1310. For example, the scanner system 1312 may be configured to measure the presence, or absence, of an SLTD within an SLTD slot, and may further be configured to measure the volume, size and/or shape of an SLTD as will be described in further detail below.

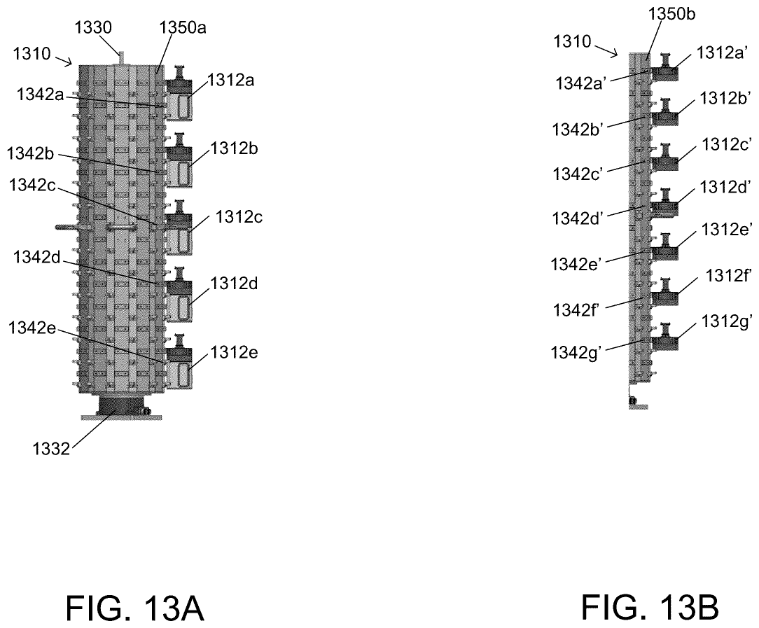

FIG. 14 shows a schematic block diagram of a scanner system 812 for use with the systems and methods described here. The scanner system 812 may comprise scanning elements configured to perform at least one measurement. In some variations, the scanner system 812 may comprise a scanner 1412, a proximity sensor 1420, and a linear encoder 1430. The scanner 1412 may be configured to scan a feature of an SLTD. For example, the scanner 1412 may comprise a barcode scanner configured to read a barcode on an outer surface of an SLTD. The proximity sensor 1420 may be configured to detect the presence, absence, and/or position of an SLTD in an SLTD slot. For example, the proximity sensor 1420 may comprise an optical sensor configured to detect a specific color on an external surface of an SLTD. In another example, the proximity sensor 1420 may be configured to transmit a signal that bounces off an external surface of either an SLTD, if present within the SLTD slot, or the SLTD slot itself, if an SLTD is absent. The signal may then be received by the proximity sensor 1420 which, in this way, may determine the presence, absence, and/or position of an SLTD within an SLTD slot. The linear encoder 1430 may be configured to measure a position of at least one component of the scanner system 812. For example, the linear encoder 1430 may comprise a sensor configured to encode the position of the linear encoder 1430 itself. In some variations, the linear encoder may be coupled to one or more of the scanner 1412 and proximity sensor 1420. In this way, the linear encoder 1430 may determine the position of one or more of the linear encoder 1430, scanner 1412, and proximity sensor 1420 as each component moves within the reagent vault.

The measurements from one or more of the scanner 1412, proximity sensor 1420, and linear encoder 1430 may be communicated to a database or communicated to the workcell controller and/or the reagent vault controller. For example, a user may review the database to find a location of a specific SLTD on the carousel of a reagent vault. In some variations, a user may review the database to find a location of an empty SLTD slot on the carousel of a reagent vault. In some variations, the database may be accessed via the controller(s). The database may contain information on the type and/or quantity of SLTDs required for a given cell process.

The scanner system 812 may further comprise components configured to move the sensing elements in at least one direction. For example, the scanner system 812 may comprise a mount 1410, an actuator 1440, an energy chain 1450, a bracket 1460, and a rail 1470. The energy chain 1450 may comprise one or more electrical wires (e.g., power or signal cables) that may be electrically coupled to one or more of the scanner 1412, the proximity sensor 1420, and the linear encoder 1430. The bracket 1460 may be configured to receive the scanning elements described above, including one or more of the scanner 1412, the proximity sensor 1420, and the linear encoder 1430. The bracket 1460 may be operatively coupled to the actuator 1440. In some variations, the actuator 1440 may comprise a pneumatic cylinder or a rotating motor with a belt and chain drive, a ball screw drive, or a rack and pinion drive. The actuator 1440 may be configured to engage with the rail 1470. For example, the actuator 1440 may be configured to move the bracket in a first direction along the rail 1470. In another example, the actuator may be configured to move the bracket in a second direction along the rail 1470, opposite the first direction. The rail 1470 may be coupled to the mount 1410. The mount 1410 may be coupled to a sidewall of the reagent vault. One or more of the mount 1410 and rail 1470 may comprise a length that is approximately equal to a length of rotating axle of the carousel. In some variations, the scanner system 812 may move independently from the carousel. In some variations, the carousel may rotate while the scanner system 812 remains stationary. In some variations, the scanner system 812 may move while the carousel remains stationary.

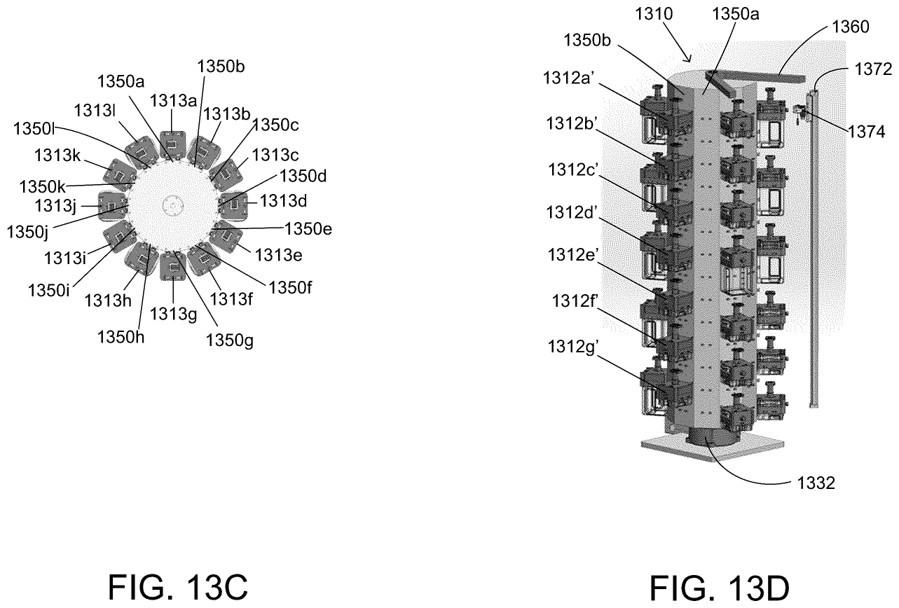

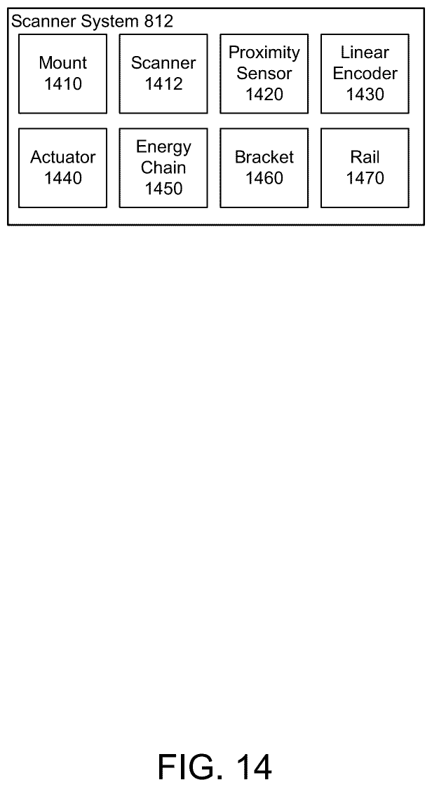

FIG. 15A and FIG. 15B show a partially exploded view and a close-up view respectively of an exemplary variation of a scanner system that may be used with the systems and methods described herein. The scanner 14312, proximity sensor 1420, and linear encoder 1430 may each be coupled to the bracket 1460. The bracket 160 may be coupled to the chain 1450. The chain 1450 may be coupled to the actuator 1440. The actuator 1440 may be coupled to the mount 1410. In this way, the bracket may move the sensing elements along an axis defined by the mount 1410. For example, the mount 1410 may be mounted in a vertical orientation along a sidewall of the reagent vault. In another example, the mount 1410 may be mounted in a horizontal orientation along a sidewall of the reagent vault.

ii. Just in Time Feedthrough

As described above, fluid devices containing reagents may be placed in a temporary repository, or a JIT feedthrough. The JIT feedthrough may also be referred to as a time sensitive reagent feedthrough, passthrough, airlock, or hatch. The JIT feedthrough may be accessed by either a human user or a robot. The JIT feedthrough may contain a limited number of SLTDs for a limited duration. For example, an SLTD containing a reagent may be placed in a JIT feedthrough. The JIT feedthrough may temporarily house reagents or other materials that are to be delivered immediately before use within the workcell. Other uses of the JIT feedthrough may be to bring in single reagent containers (e.g., for process deviations) and/or offload samples. The JIT feedthrough may provide an efficient means of inserting a limited quantity of SLTD into the workcell and/or removing a limited quantity of SLTD from the workcell. For example, the limited quantity of SLTDs may be loaded into the JIT feedthrough, decontaminated by a sterilant distributor in a short duration decontamination cycle, and transferred by the robot to the reagent vault or to an SLTI within the workcell. In this way, there is no need to open the outer door of the reagent vault, which would subsequently require a longer duration decontamination cycle of the reagent vault to be performed. In some variations, the JIT feedthrough comprises more than one feedthrough, and any number of feedthroughs may be used. In variations where more than one feedthrough is used, the feedthroughs need not be in the same general location within the workcell, nor need they be of the same configuration.

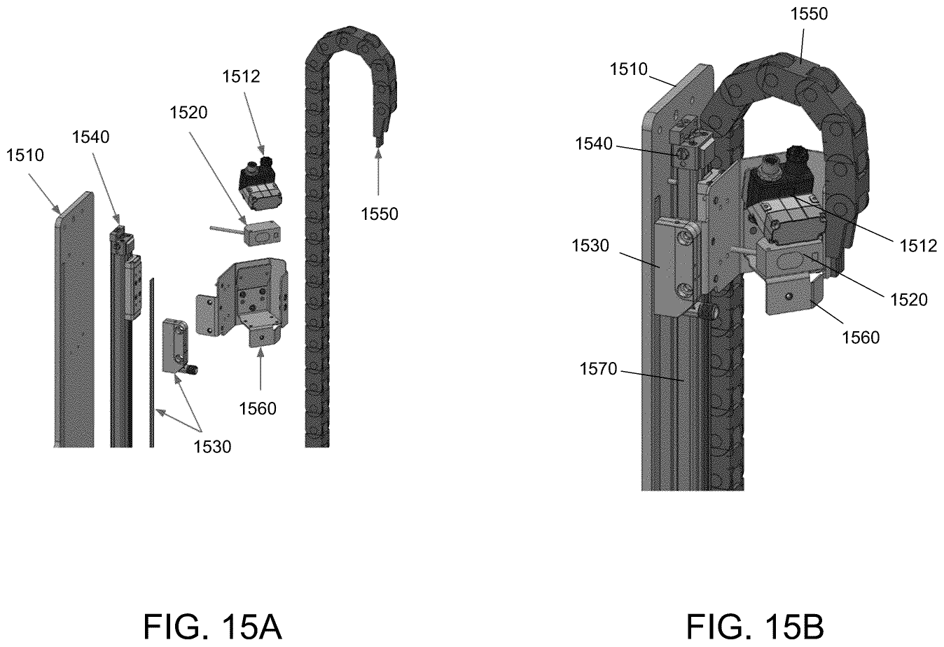

FIG. 16 provides an exemplary block diagram of one variation of a JIT feedthrough 124 that may be used with the systems and methods described herein. The JIT feedthrough 124 may comprise an inner door 1624 configured to open into the internal zone of the workcell and an outer door 1626 configured to open into the external environment. The JIT feedthrough 124 may comprise an interlock configured to lock one or more the inner door 1624 and outer door 1626. For example, the inner door 1624 may be locked if the outer door 1626 is opened by, for example, a user. In another example, the outer door 1626 may be locked if the inner door 1624 is opened by, for example, a robot.

The JIT feedthrough 124 may comprise components configured to receive at least one SLTD. In some variations, the JIT feedthrough 124 comprises a rotary system 1610. The rotary system 1610 may comprise one or more SLTD slots. The rotary system 1610 may be configured to rotate approximately 360 degrees about an axis defined by the rotary system 1610. The rotary system 1610 may be configured to rotate in response to a command sent by the workcell controller and/or the reagent vault controller. The rotary system 1610 may be configured to rotate in response to manual input from a user. In some variations, the rotary system 1610 may comprise at least one SLTD slot configured to receive at least one SLTD. The rotary system 1610 may be configured to rotate such that an SLTD slot and/or SLTD is proximate to the inner door 1624 or the outer door 1626. Any number of SLTD slots may be used, e.g., a first SLTD slot 1612a and a second SLTD slot 1612b. In some variations, the JIT feedthrough 124 may comprise three SLTD slots, four SLTD slots, five SLTD slots, or six SLTD slots. Each SLTD slot may comprise at least one index feature configured to align with a corresponding feature of an SLTD. In some variations, the SLTD comprises a first SLTD 1614a and a second SLTD 1614b.

The JIT feedthrough 124 may further comprise one or more scanning elements configured to measure at least one parameter within the JIT feedthrough 124. In some variations, the JIT feedthrough 124 may comprise a scanner system 1634. The scanner system 1634 may comprise an optical sensor configured to measure a feature on an SLTD. For example, the scanner system 1632 may comprise a barcode scanner configured to read a barcode on an outer surface of an SLTD 1614. The scanner system 1634 may be configured to identify SLTD slots that are empty or that contain an SLTD. In an exemplary variation, the scanner system 1634 may be statically mounted and the rotary system 1610 rotates such that any SLTDs contained thereon may be scanned by the scanner system 1634. In other variations, the scanner system 1634 may be configured to move in at least one direction. For example, the scanner system 1634 may be coupled to a track. In another example, the scanner system 1634 may be coupled to a robotic arm.

The JIT feedthrough 124 may further comprise a sterilant distributor 1630. The sterilant distributor 1630 may comprise an outlet coupled to a sterilant source. For example, the outlet may comprise a sterilization nozzle fluidically coupled to a sterilant source via tubing. In some variations, the sterilant distributor 1630 may comprise an ultraviolet light source. In some variations, the decontaminant may comprise one or more of ionized hydrogen peroxide, vaporized hydrogen peroxide, chlorine dioxide, or isopropyl mist. For example, the sterilization nozzle of the sterilant distributor 1630 may create a mist of ionized hydrogen peroxide. The sterilant distributor 1630 may distribute a decontaminant or sterilant to substantially all external surfaces of substantially all components within the JIT feedthrough 124. The JIT feedthrough 124 may be sized at least partially based on the sterilant distributed by the sterilant distributor 1630. For example, a certain volume of unconstrained air may be required to properly distribute a mist of ionized hydrogen peroxide and avoid condensation of the ionized hydrogen peroxide mist onto one or more surfaces within the JIT feedthrough 124.

The sterilant distributor 1630 may conduct a decontamination cycle based on a predetermined schedule. For example, a decontamination cycle may be conducted multiple times per 24-hour period. In some variations, a decontamination cycle may occur based on the occurrence of at least one predetermined event. For example, a user opening and subsequently closing an outer door 1626 of the JIT feedthrough 124 may result in a decontamination cycle occurring after the outer door 1626 has been closed. A decontamination cycle may last for a predetermined duration. In an exemplary variation, the decontamination cycle may last approximately 10 minutes. In other variations, the decontamination cycle may run for about 1 minute, about 5 minutes, about 20 minutes, about 30 minutes, or even longer. In some variations, the decontamination cycle may continue until the external surfaces within the JIT feedthrough 124 reach a desired level of decontamination as determined by periodic testing. For example, a plurality of biological indicators each configured to indicate a 3 log reduction (i.e., kill) may be exposed to a plurality of surfaces of one or more SLTDs. The exposed biological indicators may then be incubated over an incubation period (e.g., 7 days) at an elevated temperature. A lack of biological growth observed at the end of the incubation period may indicate a successful decontamination cycle. Results from previous tests may be averaged and used to inform future decontamination cycles, such that instantaneous results are not required to end a specific decontamination cycle within the JIT feedthrough. A similar process may be used for the decontamination cycle performed in the reagent vault described herein.

In some variations, the duration of the decontamination cycle may be at least partially dependent on an air temperature within the JIT feedthrough 124. For example, an air temperature within the JIT feedthrough 124 that is greater than a room temperature in the external environment outside of the workcell may decrease the time required to perform a decontamination cycle. In another example, an air temperature within the JIT feedthrough 124 that is lower than a room temperature in the external environment outside of the workcell may increase the time required to perform a decontamination cycle. In another example, humidity within the JIT feedthrough may also impact the time required to perform a decontamination cycle. The interlock may stay engaged for one or more of the inner door 1624 and outer door 1626 until the decontamination cycle is completed.

The JIT feedthrough 124 may further comprise at least one component configured to filter the air before or after a decontamination cycle. In some variations, the JIT feedthrough 124 may comprise an aerator system 1632. The purpose of the aerator system 1632 is to remove particles, such as H₂O₂ particles, from the air until the air reaches a level safe for human exposure. In some variations, the aerator system 1632 may comprise a fan filter unit fluidically coupled to a filter. The filter may comprise one or more of a catalyst and an activated carbon filter. The catalyst may be configured to remove sterilant from the air within the JIT feedthrough. In some embodiments, the activated carbon filter, which may be replaceable, may be configured to remove particulates and/or sterilant from the air within the JIT feedthrough. The aerator system 1632 may be a closed loop system or an open loop system. In the open loop system, clean air (e.g., devoid of H₂O₂ particles) may be drawn into the JIT feedthrough from an external environment (e.g., within the workcell or a laboratory environment external to the workcell), combined with air within the JIT feedthrough, filtered via the catalyst of the aerator system 1632, and expelled back into the external environment. The open loop system may advantageously filter air within the JIT feedthrough and air external to the JIT feedthrough, which may prevent further particulates from entering the JIT feedthrough if a JIT feedthrough door is opened. In the closed loop system, air may be drawn from the JIT feedthrough, filtered via the catalyst and/or activated carbon filter of the aerator system 930, and expelled back into the JIT feedthrough. The closed loop system may advantageously maintain a colder set air temperature within the JIT feedthrough than the open loop system. The aerator system 1632 may be configured to operate simultaneously with the sterilant distributor 1630. In some variations, the aerator system 1632 may be configured to operate after the completion of a decontamination cycle performed by the sterilant distributor 1630.

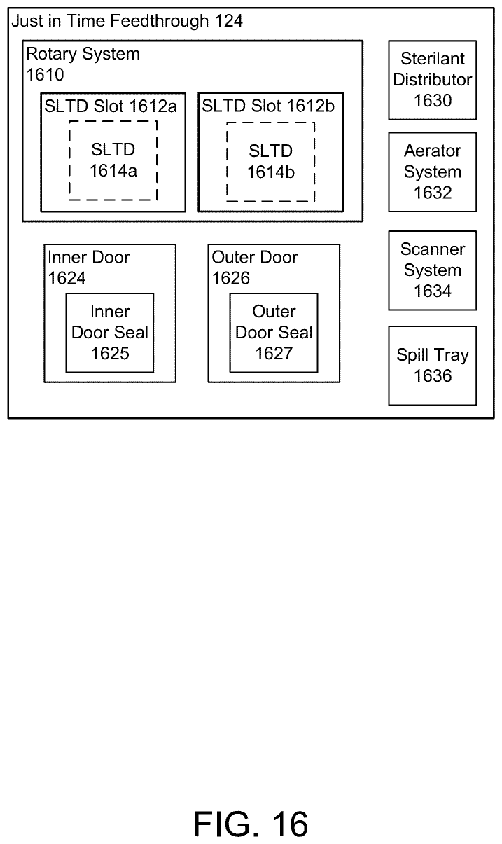

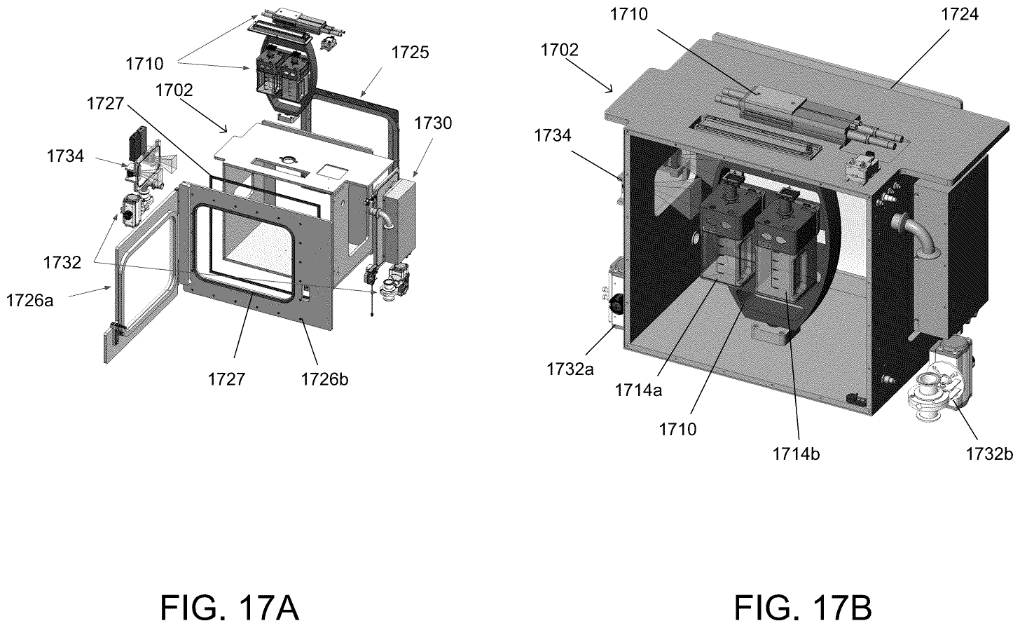

FIG. 17A shows a partially exploded view of one variation of a JIT feedthrough suitable for use with the system and methods described herein and FIG. 17B shows a partially constructed view of the variation shown in FIG. 17A. The JIT feedthrough 124 may comprise a cabinet or housing 1702 configured to receive the rotary system 1710. The cabinet 1702 may be coupled to the outer door and the inner door. The outer door may comprise a first outer door portion 1726a and a second outer door portion 1726b. The first outer door portion 1726a may be coupled to the second outer door portion 1726b via a hinge. In this way, the first outer door portion 1726a may be separated from the second outer door portion 1726b, while the latter remains stationary relative to the cabinet 1702. In some variations, there may be an outer door seal 1727 between the second outer door portion 1726b and the cabinet 1702. The outer door seal 1727 may be configured to create a fluid-tight seal. The inner door may be coupled to the cabinet 1710 via a hinge. In some variations, the inner door may be coupled to an inner door seal 1725. The inner door seal 1725 may be configured to create a fluid-tight seal.

The JIT feedthrough may further comprise an aerator system including a first aerator valve 1732a and a second aerator valve 1732b. The first aerator valve 1732a may be coupled to a first sidewall of the JIT feedthrough and the second aerator valve 1732b may be coupled to a second sidewall of the JIT feedthrough. Each of the aerator valves 1732a, 1732b may be in fluid communication with each other, the internal environment within the JIT feedthrough, and/or the environment external to the JIT feedthrough. Each of the aerator valves 1732a, 1732b may have an open position and a closed position. In the open position, each aerator valve may provide a fluid path such that air may flow in and/or out of the JIT feedthrough. In the closed position, air may not flow through any one of the aerator valves 1732a, 1732b. In this way, the aerator valves 1732a, 1732b may perform an aeration cycle of the air within the JIT feedthrough. The JIT feedthrough may further comprise the scanner system 1734. In some variations, the scanner system 1734 may comprise a plurality of sensors, with each sensor comprising the same or different functionality. For example, the scanner system 1734 may comprise one or more of a proximity sensor, a scanner, a gas sensor, a position sensor, and a pressure sensor. In some variations, the scanner system 1734 may be coupled to an external surface of a sidewall of the JIT feedthrough. In some variations, the scanner system 1734 may be configured to measure at least one parameter associated with the rotary system 1710 positioned within the internal environment of the JIT feedthrough.

iii. Waste Unit

As described above, at least one SLTD may be placed in a waste container after completion of one or more cell processes within the workcell. The waste container may be accessed by either a human user or a robot. The waste container may contain a plurality of SLTD for an extended duration. The waste container may comprise a waste unit. The waste unit may comprise a shelf configured to receive a fluid device such as an SLTD. The waste unit may comprise a plurality of shelves, such as 2 shelves, 3 shelves, 4 shelves, 5 shelves, 6 shelves, 7 shelves, 8 shelves, 9 shelves, or 10 shelves. Each shelf may comprise one or more rows. Each row may comprise one or more slots configured to receive a fluid device, such as an SLTD. In this way, each shelf may receive a plurality of fluid devices. The fluid devices may be the same size or may vary in size. For example, a shelf may be configured to receive an SLTD with a storage volume of 0.5 L or 1 L. An SLTD with a storage volume of 0.5 L may be received by an SLTD slot configured to receive an SLTD with a storage volume of 1 L. In some variations, an SLTD slot configured to receive an SLTD with a storage volume of 0.5 L may not receive an SLTD with a storage volume of 1 L.

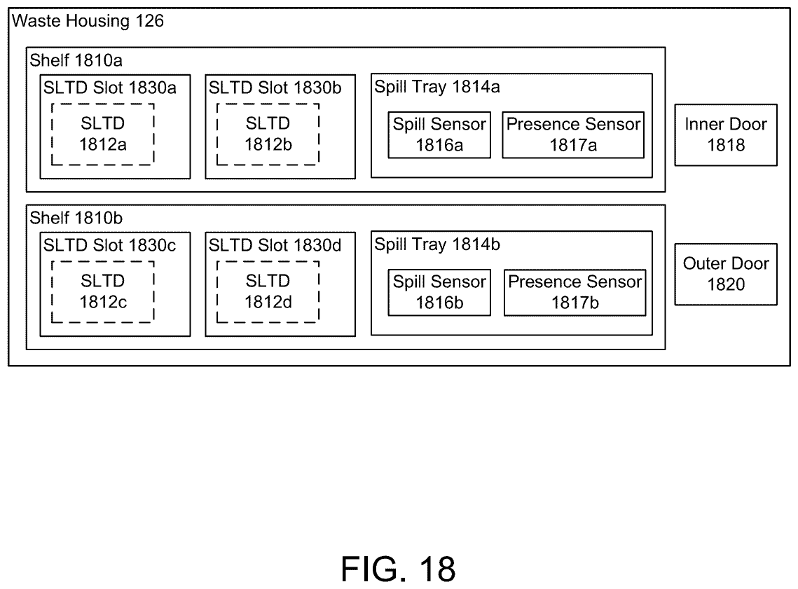

FIG. 18 shows a schematic block diagram of an exemplary variation, such as waste unit 126. The waste unit 126 may comprise an inner door 1818 and an outer door 1820. The waste unit 126 may comprise an interlock configured to lock one or more the inner door 1818 and outer door 1820. For example, the inner door 1818 may be locked if the outer door 1820 is opened by, for example, a user. In another example, the outer door 1820 may be locked if the inner door 1818 is opened by, for example, a robot.

The waste unit 126 may comprise a first shelf 1810a and a second shelf 1810b. Each of the shelves 1810a,b may be coupled to the waste unit 126 in any suitable manner. For example, the shelf 1810a may comprise one or more of a wheel, rail, nail, screw, or any mechanical fastener configured to couple to a corresponding feature on an inner surface of a sidewall of the waste housing 126 (e.g., rail, hole, opening, and/or clip). Each shelf 1810a,b may further comprise at least one SLTD slot configured to receive an SLTD. In some variations, the shelf 1810 may comprise 10 SLTD slots, 20 SLTD slots, 30 SLTD slots, 40 SLTD slots, 50 SLTD slots, 60 SLTD slots, 70 SLTD slots, 80 SLTD slots, 90 SLTD slots, or 100 SLTD slots. In some variations, the total capacity of the waste unit may be a function of the size of each SLTD.

Each shelf of the waste unit described herein may include a spill tray, a spill sensor, and a presence sensor. In this way, the exemplary waste unit 126 may comprise a spill tray 1814a,b, a spill sensor 1816a,b, and a presence sensor 1817a,b corresponding to the respective shelf 1810a,b. The spill tray 1814a,b may be configured to contain about 1 L of fluid. In some variations, the spill tray 1814a,b may be configured to contain other amounts of fluids, such as about 1.5 L, about 2 L, about 2.5 L, and about 3 L of fluid. The spill sensor 1816a,b may be configured to determine the presence or absence of fluid within the spill tray 1814a,b. The spill sensor 1816a,b may be further configured to determine the amount of fluid within the spill tray 1814a,b. The spill sensor may be operatively coupled to the workcell and/or reagent vault controller(s). The presence sensor 1817a,b may be configured to determine the presence, absence, and/or position of an SLTD within the waste unit 126. The presence sensor 1817a,b may determine whether an SLTD is askew, tilted, and/or tipped over. The presence sensor 1817a,b may comprise a laser sensor. Any presence sensor may be coupled to an inner surface of a sidewall of the waste unit such that a presence sensor is, for example, aligned with each row of each shelf of the waste unit.

The waste unit 126 may track the quantity of SLTD contained therein and provide real-time capacity updates to the workcell and/or reagent vault controller(s). Once the waste unit 126 approaches or reaches maximum capacity, an alert may be sent to the controller(s). In some variations, a user may open the outer door 1820 to empty the waste unit 126 in response to the alert. If the inner door 1818 is locked because the outer door 1820 is open, the robot may, for example, temporarily transfer at least one SLTD to the reagent vault that would have otherwise been transferred to the waste unit 126. As a further example, once the inner door 1818 becomes unlocked, the robot may subsequently remove at least one SLTD from the reagent vault and transfer it to the waste unit 126.

An SLTD may be removed from one or more of the waste unit, reagent vault, AIS, SLTI, and JIT feedthrough described herein and moved to a scale configured to weigh at least one SLTD. For example, a user may measure the weight of an SLTD before loading the SLTD into one or more of the reagent vault, JIT feedthrough, and waste unit. In another example, a user may measure the weight of an SLTD after unloading the SLTD from one or more of the reagent vault, JIT feedthrough, and waste unit. The mass measurement obtained via the scale may advantageously indicate the presence and/or quantity of a fluid within the SLTD.

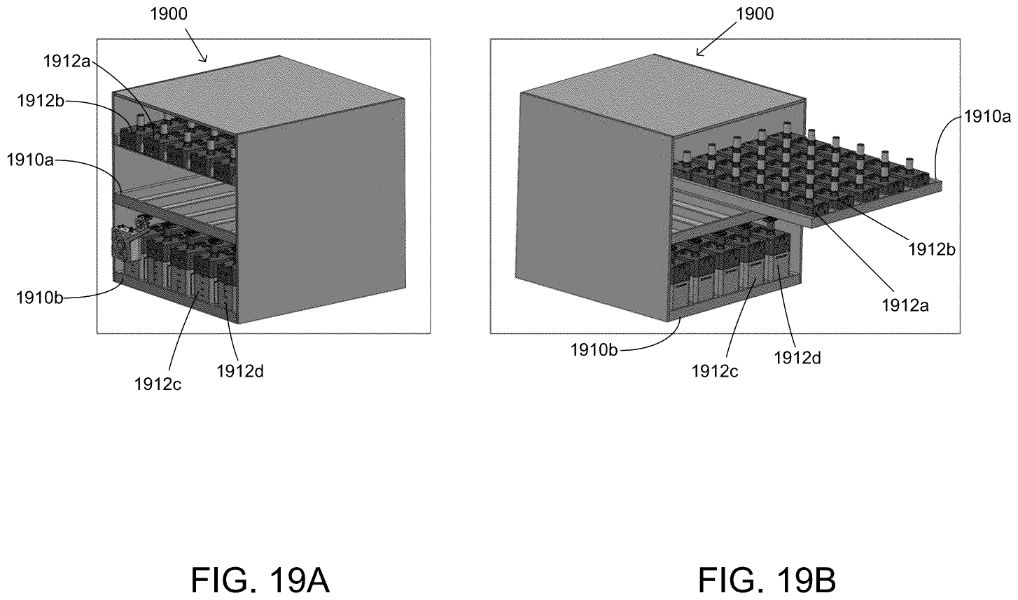

FIGS. 19A and 19B show an exemplary variation of a waste unit 1900. In FIG. 19A, the first shelf 1910a and second shelf 1910b are each in a first retracted configuration. The first retracted configuration is such that each of the shelves 1910a,b is fully contained within the waste unit 126. In FIG. 13B, the first shelf 1910a is in a second extended configuration. The second extended configuration is such that a shelf (e.g., 1910a) is extending from the waste unit 1900. The shelf may move via wheels coupled to a corresponding feature of the waste unit 1900. The waste unit 1900 may contain a plurality of SLTDs. In some variations, the first shelf 1910a may contain up to and including 30 SLTDs, including a first SLTD 1912a and a second SLTD 1912b. The second shelf 1910b may contain up to and including 30 SLTDs, including a third SLTD 1912c and a fourth SLTD 1912d.

A waste sensor (not shown) may be coupled to a sidewall of a waste unit. In some variations, a plurality of waste sensors may be fixedly coupled to the sidewall of the waste unit. Each of the plurality of waste sensors may be positioned along a longitudinal dimension of the waste unit. In an exemplary variation, one or more waste sensors may correspond to each row of each shelf of the waste unit. Each waste sensor may be configured to measure a presence and/or location of an SLTD within an SLTD slot. Additionally or alternatively, each waste sensor may be configured to determine if an SLTD is out of position, askew, and/or fallen over. In this way, a robot may receive a measurement from the waste sensor and respond accordingly. For example, a waste sensor may determine that the waste unit is partially or substantially empty (i.e., devoid of SLTDs) and the robot may respond by moving one or more SLTDs into the waste unit. In another example, a waste sensor may determine that the waste unit is substantially full (i.e., a majority of SLTD slots contain an SLTD). The robot may respond by transferring a waste SLTD (e.g., an SLTD that is empty or contains a cell processing byproduct) to a reagent vault for temporary storage rather than the waste unit. Once the waste sensor determines that the waste unit has been substantially emptied (either by a user or a robot), the robot may then transfer the temporarily stored waste SLTD from the reagent vault to the waste unit. In some variations, the waste sensor may be configured to move in at least direction within the waste unit. For example, the waste sensor may be coupled to a robotic arm. In another example, the waste sensor may be coupled to a rail within the waste unit.

### II. Methods of Reagent Storage

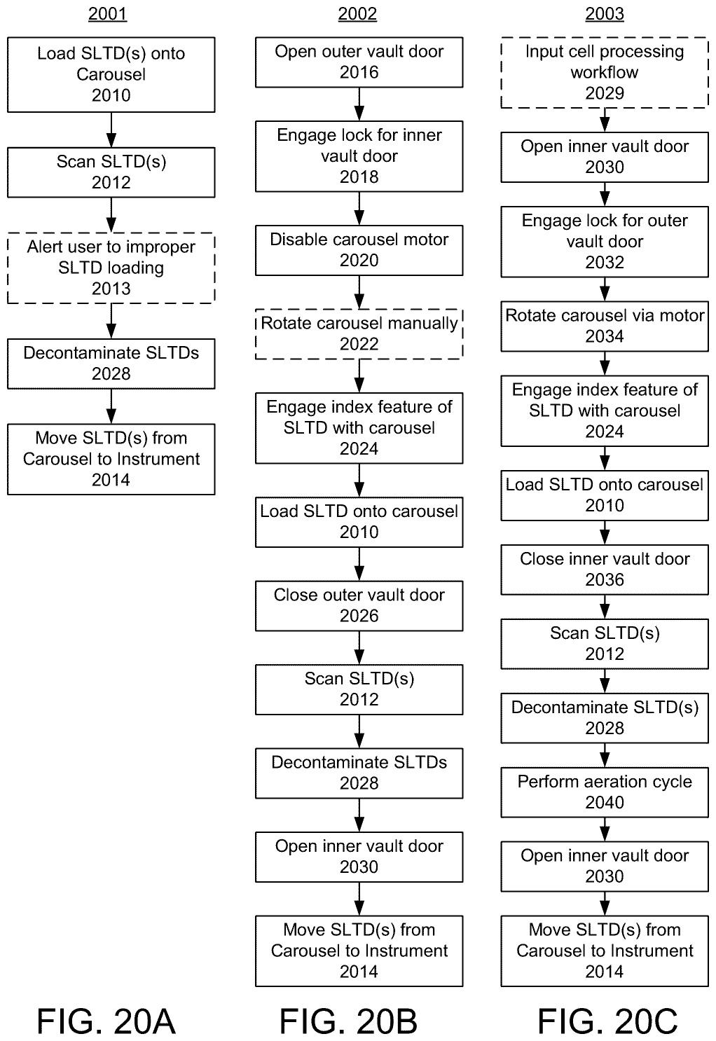

Generally, the systems and devices described herein may perform one or more methods of storing and/or accessing cell processing products during an automated cell processing product. FIGS. 20A-C provide flowcharts of illustrative methods of storing SLTDs in a reagent vault system as described herein. As shown in FIG. 20A, a method 2001 may comprise loading an SLTD onto a carousel and subsequently unloading the SLTD from the carousel. The method 2001 may include loading an SLTD onto a carousel in a step 2010. In some variations, the SLTD may be placed in an empty SLTD slot on a column of the carousel by a user after opening an outer door of a reagent vault. In further variations, the SLTD may be placed in an empty SLTD slot on a column on the carousel by a robot after opening an inner door of a reagent vault. In some variations, a plurality of SLTDs may be loaded onto the carousel. In some variations, at least two of the plurality of SLTDs are of a different size. Once the SLTD is loaded on the carousel, the SLTD is scanned in a step 2012. The SLTD may be scanned by a scanner system within the reagent vault. The scanner (e.g., barcode reader, presence sensor, proximity sensor) may move along a rail that runs parallel to the rotating axle of the reagent vault. The carousel may rotate via a carousel motor to facilitate scanning by the scanner system. In some variations, the scanner system may scan at least two SLTDs of different sizes to determine that each of the SLTD are of different size relative to each other. In some variations, the method 2001 may further include alerting a user to an improper loading condition related to an SLTD in a step 2013. For example, the scanner system may determine an SLTD required for a specific process was not properly loaded onto the carousel. In such an example, an alert may then be generated that indicates an incorrect quantity and/or type of SLTD was loaded. The alert may further indicate which type and/or quantity of SLTD should be replaced and/or loaded. In some variations, an alert may be based on a liquid temperature sensor or an air temperature sensor that measures a temperature greater than a threshold temperature. In response to any condition described herein, an alert may be generated. In some variations, the alert comprises an alarm comprising one or more of an audible alarm, a visual alarm, and a virtual alarm. The SLTD within the reagent vault may then be decontaminated in a step 2028. The decontamination may be performed by a sterilant distributor. The sterilant distributor may provide a sterilant to sterilize the SLTD. In some variations, the sterilant is ionized hydrogen peroxide (iHP), vaporized hydrogen peroxide (VHP), chlorine dioxide (CD), or isopropyl mist. In an exemplary variations, the sterilant distributor may perform a decontamination cycle that lasts for approximately one hour. Once the decontamination cycle has been performed, the SLTD may be moved from the carousel to an instrument within the workcell in a step 2014. For example, the SLTD may be removed from the carousel and moved to an instrument by a robot.

As shown in FIG. 20B, a method 2002 may comprise a user manually loading an SLTD onto a carousel and a robot subsequently unloading the SLTD from the carousel. The method 2002 may include opening an outer door of the reagent vault in a step 2016. In some variations, the outer door may be opened by a user. In further variations, the outer door may be opened via a signal sent by a workcell and/or reagent vault controller. Once the outer door is open, the inner door of the reagent vault may be locked in a step 2018. The inner door may be locked via an interlock within the reagent vault. In some variations, the interlock may be engaged manually via input from a user. In further variations, the interlock may be automatically engaged in response to at least one signal transmitted by a door status sensor. Carousel motor may be disabled in a step 2020. In some variations, the carousel motor may be disabled via input from a user. In further variations, the carousel motor may be disabled automatically via the workcell and/or reagent vault controller. The carousel may then be rotated manually by a user in a step 2022. The carousel may be rotated based on the quantity of SLTD contained on a column of the carousel. For example, the carousel may be rotated such that a column containing a plurality of SLTD is proximal to the outer door to facilitate a user removing an SLTD. In another example, the carousel may be rotated such that a column with at least one empty SLTD slot is proximate to the outer door. If a column with an empty SLTD slot is already proximate to the outer door, the carousel may not need to be rotated. Then, at least one index feature of the SLTD may be engaged with a corresponding feature of an empty SLTD slot of the carousel in a step 2024. For example, a user may align the index feature of the SLTD with the corresponding feature of the SLTD slot. Then, the SLTD may be fully inserted into the SLTD slot in a step 2010. Once the SLTD has been loaded, the outer door may be closed in a step 2026. For example, the outer door may be closed by the user. In another example, the outer door may be closed automatically based on a command sent by the workcell and/or reagent vault controller. The SLTD may be scanned in a step 2012. The SLTD may be scanned by a scanner system within the reagent vault. The scanner (e.g., barcode reader, presence sensor, proximity sensor) may move along a rail that runs parallel to the rotating axle of the reagent vault. The carousel may rotate via a carousel motor to facilitate scanning by the scanner system. In some variations, the scanner system may scan at least two SLTDs of different sizes to determine that each of the SLTD are a different size relative to each other. The SLTD within the reagent vault may then be decontaminated in a step 2028. The decontamination may be performed by a sterilant distributor. The sterilant distributor may provide a sterilant to sterilize the SLTD. In some variations, the sterilant is ionized hydrogen peroxide (iHP), vaporized hydrogen peroxide (VHP), chlorine dioxide (CD), or isopropyl mist. In an exemplary variations, the sterilant distributor may perform a decontamination cycle that lasts for approximately one hour. Then, the inner vault door may be opened in a step 2030. In some variations, the inner vault door may be opened via a robot. In further variations, the inner vault may be opened via a signal sent from the workcell and/or reagent vault controller. At least one SLTD may then be removed from the carousel and moved to another location within the workcell in a step 2014. The SLTD may be removed and moved by a robot using an end effector engagement feature on the robot and a corresponding engagement feature on the SLTD. In some variations, the SLTD may be removed and moved automatically, without any input from a user. In some variations, the SLTD may be moved to the waste unit.

As shown in FIG. 20C, a method 2003 may comprise executing a cell processing workflow via a robot loading an SLTD onto a carousel and subsequently unloading the SLTD from the carousel. The method 2003 may include inputting a cell processing workflow in a step 2029. For example, a user may input a cell processing workflow into the workcell controller. The workcell controller may be configured to execute the cell processing workflow. The workcell controller may communicate with the one or more of the reagent vault system and robot to execute the cell processing workflow. In a step 2030, the inner door of the reagent vault may be opened. In some variations, the inner door may be opened by a user. In further variations, the inner door may be opened via a signal sent by the workcell and/or reagent vault controller. In still further variations, the inner door may be opened by the robot. Once the inner door is open, the outer door of the reagent vault is locked in a step 2032. The outer door may be locked via an interlock within the reagent vault. In some variations, the interlock may be engaged manually via input from a user. In further variations, the interlock may be automatically engaged in response to at least one signal transmitted by a door status sensor. The carousel may then be rotated automatically in a step 2032. The carousel may be rotated based on the quantity of SLTDs contained on a column of the carousel. For example, the carousel may be rotated such that a column containing a plurality of SLTDs is proximate to the inner door to facilitate a robot removing an SLTD. In another example, the carousel may be rotated such that a column with at least one empty SLTD slot is proximate to the inner door. If a column with an empty SLTD slot is already proximate to the inner door, the carousel may not need to be rotated. Then, at least one index feature of the SLTD may be engaged with a corresponding feature of an empty SLTD slot of the carousel in a step 2024. For example, a robot may align the index feature of the SLTD with the corresponding feature of the SLTD slot. Then, the SLTD may be fully inserted into the SLTD slot in a step 2010. Once the SLTD has been loaded, the inner door may be closed in a step 2036. For example, the inner door may be closed by the robot. In another example, the inner door may be closed automatically based on a command sent by the workcell controller. Then, the SLTD may be scanned in a step 2012. The SLTD may be scanned by a scanner system within the reagent vault. The scanner (e.g., barcode reader, presence sensor, proximity sensor) may move along a rail that runs parallel to the rotating axle of the reagent vault. The carousel may rotate via a carousel motor to facilitate scanning by the scanner system. In some variations, the scanner system may scan at least two SLTDs of different sizes to determine that each of the SLTD are a different size relative to each other. The SLTD within the reagent vault may then be decontaminated in a step 2028. The decontamination may be performed by a sterilant distributor. The decontaminate distributor may provide a sterilant to sterilize the SLTD. In some variations, the sterilant is ionized hydrogen peroxide (iHP), vaporized hydrogen peroxide (VHP), chlorine dioxide (CD), or isopropyl mist. In some variations, the sterilant distributor may perform a decontamination cycle that lasts for approximately one hour. Then, an aeration cycle may be performed within the reagent vault in a step 2040. The aeration cycle may be performed by an aeration system such that any remaining sterilant (e.g., H₂O₂) within the reagent vault is removed. Then, the inner vault door may be opened in a step 2030. In some variations, the inner vault door may be opened via a robot. In further variations, the inner vault may be opened via a signal sent from the workcell controller. At least one SLTD may then be removed from the carousel and moved to another location within the workcell in a step 2014. The SLTD may be removed and moved by a robot. In some variations, the SLTD may be removed and moved automatically, without any input from a user. In some variations, the SLTD may be transferred to the waste unit.

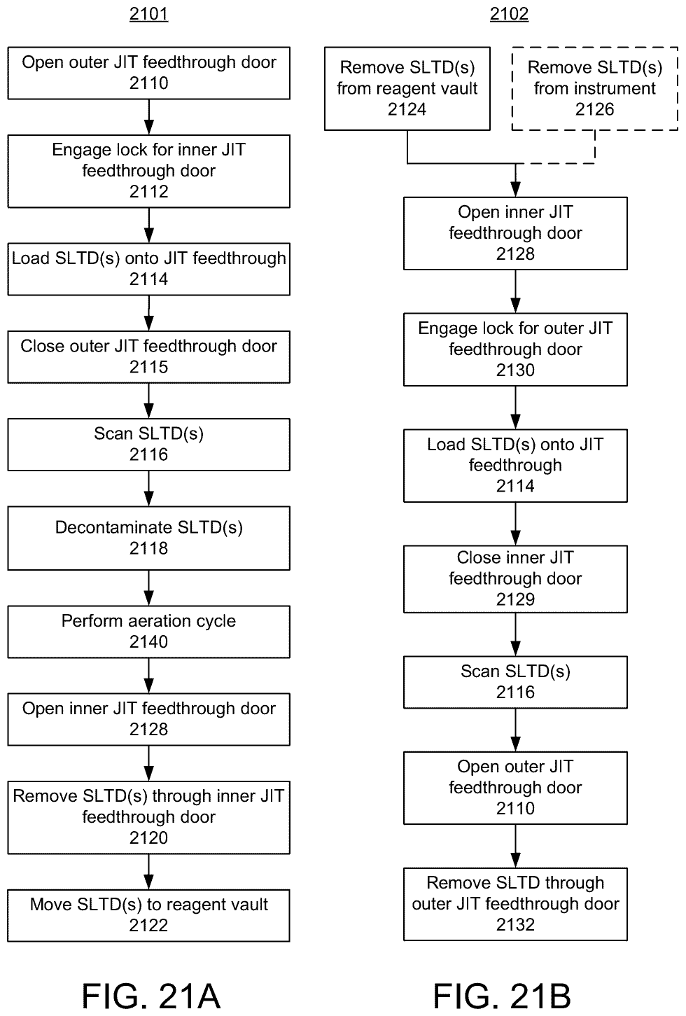

FIGS. 21A-B provide illustrative flowcharts of methods of storing SLTD in the just in time feedthroughs as described herein throughout. As shown in FIG. 21A, a method 2101 may comprise a user loading an SLTD into the JIT feedthrough and a robot subsequently unloading the SLTD from the JIT feedthrough. The method 2101 may include, in a step 2110, opening an outer door of the JIT feedthrough. In some variations, the outer door may be opened by a user. In further variations, the outer door may be opened via a command sent by the workcell controller. Once the outer door is open, an interlock may be engaged with the inner door in a step 2112. In some variations, the interlock may be engaged manually via input from a user. In further variations, the interlock may be automatically engaged. The interlock may prevent the inner door from being opened while the outer door is open. Then, at least one SLTD may be loaded into the JIT feedthrough by a user in a step 2114. In some variations, at least one index feature of the SLTD may be engaged with a corresponding feature of an empty SLTD slot of the JIT feedthrough. Once at least one SLTD is loaded, the outer door may be closed in a step 2115. The outer door may be closed manually by a user. In some variations, the outer door may be closed via a command sent by the workcell controller. Then, the SLTD within the JIT feedthrough may be scanned in a step 2116. The SLTD may be scanned by the scanner system. In some variations, the scanner system may move in at least one direction to facilitate scanning the SLTD. Then, at least one SLTD 1614 within the JIT feedthrough may be decontaminated in a step 2118. The decontamination may be performed by a sterilant distributor. In an exemplary variation, the sterilant distributor may perform a decontamination cycle that lasts for approximately 10 minutes. Then, an aeration cycle may be performed within the JIT feedthrough in a step 2140. The aeration cycle may be performed by an aeration system such that any remaining sterilant (e.g., H₂O₂) within the JIT feedthrough is removed. After the aeration cycle, the inner JIT feedthrough door may be opened in a step 2128. The inner door may be opened by the robot. In some variations, the inner door may be opened by a command sent by the workcell controller. Then, at least one SLTD may be removed from the JIT feedthrough through the inner door in a step 2120. For example, at least one SLTD may be removed by the robot. The at least one SLTD may then be moved to the reagent vault in a step 2122. In some variations, the at least one SLTD may be moved to another location within the workcell.

As shown in FIG. 21B, a method 2102 may comprise a robot loading an SLTD into the JIT feedthrough and a user subsequently unloading the SLTD from the JIT feedthrough. The method 1502 may include, in a step 1524, removing at least one SLTD from the reagent vault. For example, the SLTD may be removed by a robot. In some variations, at least one SLTD may be removed from an instrument within the workcell in a step 1526. For example, at least one SLTD may be removed from the AIS instrument by a robot. Then, in a step 2128, an inner door of the JIT feedthrough may be opened. In some variations, the inner door may be opened via a command sent by the workcell and/or reagent vault controller(s). In further variations, the inner door may be opened by the robot. Once the inner door is open, an interlock may be engaged with the outer door in a step 2130. The interlock may prevent the outer door from being opened while the inner door is open. In some variations, the interlock may be engaged manually via input from a user. In further variations, the interlock may be automatically engaged. Then, at least one SLTD may be loaded into the JIT feedthrough in a step 2114. In some variations, the SLTD may be loaded into an empty SLTD slot of the JIT feedthrough by the robot. In some variations, at least one index feature of the SLTD may be engaged with a corresponding feature of an empty SLTD slot of the JIT feedthrough. Once the SLTD is loaded, the inner door may be closed in a step 1529. In some variations, the inner door may be closed via a command sent by the workcell and/or reagent vault controller(s). In further variations, the inner door may be closed by the robot. Then, the SLTD within the JIT feedthrough may be scanned in a step 2116. The SLTD may be scanned by the scanner system. In some variations, the scanner system may move in at least one direction to facilitate scanning the SLTD. After the scan, the outer JIT feedthrough door may be opened in a step 2110. In some variations, the outer door may be opened via a command sent by the workcell and/or reagent vault controller(s). In further variations, the outer door may be opened by the user. Then, at least one SLTD may be removed from the JIT feedthrough through the outer door in a step 2120. For example, at least one SLTD may be removed by a user.

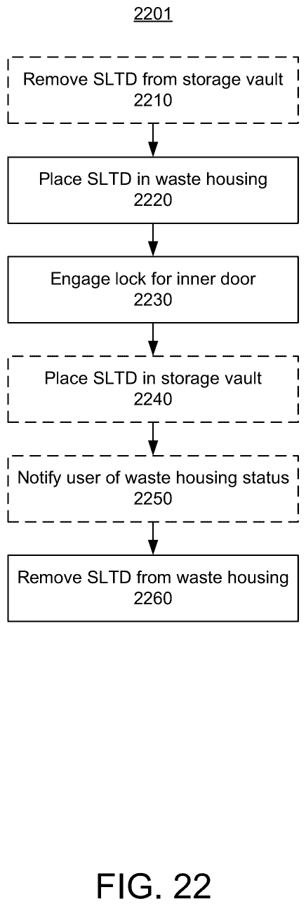

FIG. 22 provides an illustrative flowchart of a method of storing SLTDs in the waste unit. A method 2201 may comprise removing an SLTD from a reagent vault in a step 2210. For example, a SLTD may be removed by a robot after opening an inner door. Then, the robot may transport the SLTD to a waste unit. For example, the inner door of the waste unit may have been previously opened by the robot. In some variations, the inner door may open automatically via a command sent by the workcell and/or reagent vault controller(s). Then, the robot may place the SLTD into the waste unit in a step 2220. In some variations, a plurality of SLTDs may be placed into the waste unit. In some variations, each of the SLTD slots of each waste unit shelf may be filled. The inner door may then be closed by, for example, the robot. In some variations, the inner door may be closed via a command sent by the workcell and/or reagent vault controller(s). Once the inner door has been closed, a lock may be engaged to prevent the inner door from opening in a step 2230. The lock may be engaged automatically or via a manual command input by a user via the workcell and/or reagent vault controller(s). In some variations, the robot may then transport at least one SLTD from one location within the workcell to the reagent vault. For example, the robot may remove one SLTD from the AIS instrument and transport it to the reagent vault. The robot may not open the inner door while the interlock is engaged. Then, in a step 2250, a notification may be sent to a user indicating the status of the waste unit. For example, the notification may indicate one or more of the quantity, identity (e.g., barcode number), and location of SLTD that are contained within the waste unit. Then, a user may open the outer door of the waste unit to remove the SLTD from the waste unit. In some variations, the outer door may remain open until substantially all of the SLTD are removed from the waste unit. Then, the outer door may be closed by, for example, the user. In some variations, the outer door may close via a command sent by the controller. Once the outer door has been closed, the interlock engaged with the inner door may be released so that the inner door may be opened when required.

While described above as containing certain steps, it should be understood that the methods of cell processing may include any subset of cell processing steps in any suitable order.

All references cited are herein incorporated by reference in their entirety.

Throughout this application, the term “about” is used to indicate that a value includes the inherent variation of error for the device or the method being employed to determine the value, or the variation that exists among the samples being measured. Unless otherwise stated or otherwise evident from the context, the term “about” means within 10% above or below the reported numerical value (except where such number would exceed 100% of a possible value or go below 0%). When used in conjunction with a range or series of values, the term “about” applies to the endpoints of the range or each of the values enumerated in the series, unless otherwise indicated. As used in this application, the terms “about” and “approximately” are used as equivalents.

While embodiments of the present invention have been shown and described herein, those skilled in the art will understand that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1. A reagent vault system for use in cell processing comprising:
a refrigeration unit for storing cell processing reagents;
a rotating carousel configured to receive one or more fluid devices, wherein the one or more fluid devices are configured to store the cell processing reagents; and
at least one sensor for measuring at least one parameter of the reagent vault system.

2. The reagent vault system of claim 1 wherein the at least one sensor is a temperature sensor, pressure sensor, particulate sensor, relative humidity sensor, hydrogen peroxide sensor, or combinations thereof.

3. The reagent vault system of claim 2 wherein the at least one sensor is a temperature sensor.

4. The reagent vault system of claim 1 further comprising a scanner, wherein the scanner is configured to scan a bar code on the one or more fluid devices and detect a size of the one or more fluid devices.

5. The reagent vault system of claim 1 wherein the reagent vault system further comprises a sterilization nozzle to provide sterilant to the one or more fluid devices.

6. The reagent vault system of claim 1 further comprising multiple refrigeration units.

7. The reagent vault system of claim 1, wherein the one or more fluid devices are of different size.

8. The reagent vault system of claim 1 further comprising a robotic arm for transferring the one or more fluid devices from the rotating carousel to one or more instruments within a cell processing workcell.

9. The reagent vault system of claim 8, wherein the robotic arm comprises a fluid device engagement feature end effector for coupling to the one or more fluid devices.

10. The reagent vault system of claim 1 further comprising a just-in-time feedthrough for loading one or more time-sensitive reagents into the reagent vault system.

11. The reagent vault system of claim 1 further comprising a cartridge feedthrough for loading one or more cartridges into the reagent vault system.

12. The reagent vault system of claim 1 further comprising a waste unit.

13. The reagent vault system of claim 1 wherein the refrigeration unit, the rotating carousel, and the at least one sensor for monitoring at least one parameter of the reagent vault system are housed within a single unit, wherein the unit comprises an outer door for user access to the rotating carousel and an inner door for access to cell processing instruments within a sterile workcell.

14. The reagent vault system of claim 13 further comprising an interlock, wherein the interlock locks the outer door when the inner door is open.

15. The reagent vault system of claim 10, wherein the just-in-time feedthrough comprises a sterilization nozzle to provide sterilant to the one or more time-sensitive reagents.

16. The reagent vault system of claim 3 further comprising an alarm for alerting a user when the temperature sensor measures a temperature greater than a threshold temperature.

17. The reagent vault system of claim 16, wherein the threshold temperature can be a temperature in a range between about 2 degrees C. and about 8 degrees Celsius.

18. The reagent vault system of claim 16, wherein the alarm is an audible alarm, a visual alarm, a virtual alarm, or a combination thereof.

19. The reagent vault system of claim 1 further comprising a controller.

20. The reagent vault system of claim 19, wherein the controller is configured to activate the at least one sensor, activate a scanner, activate an interlock, activate an alarm, activate a robotic arm, or a combination thereof.

21. A method of automated cell processing comprising:
loading a rotatable carousel with a fluid device, wherein the fluid device comprises a bar code, and contains a cell processing reagent therein,
wherein the rotatable carousel is within a reagent vault system, the reagent vault system comprising a refrigeration unit, a scanner, at least one sensor for measuring at least one parameter of the reagent vault system, and a robotic arm;
scanning the fluid device bar code with the scanner;
moving the fluid device from the rotatable carousel to an instrument within a cell processing workcell using the robotic arm.

22. The method of claim 21, wherein the at least one sensor is a temperature sensor, pressure sensor, particulate sensor, relative humidity sensor, hydrogen peroxide sensor, or combinations thereof.

23. The method of claim 22, wherein the at least one sensor is a temperature sensor, and the method further comprises measuring a temperature with the at least one temperature sensor.

24. The method of claim 21 further comprising providing a sterilant to sterilize the fluid device.

25. The method of claim 24, wherein the sterilant is ionized hydrogen peroxide (iHP), vaporized hydrogen peroxide (VHP), chlorine dioxide (CD), ultraviolet (UV) rays, or isopropyl mist.

26. The method of claim 21 further comprising loading the rotatable carousel with multiple fluid devices.

27. The method of claim 26, wherein at least two of the fluid devices are of a different size.

28. The method of claim 27 further comprising scanning the at least two fluid devices of different size with the scanner to determine that the fluid devices are of different size.

29. The method of claim 23 further comprising alerting a user if the measured temperature is greater than a threshold temperature.

30. The method of claim 21, wherein the rotatable carousel is loaded with fluid devices according to a cell processing workflow.

31. (canceled)
